(19) United States
(12) Patent Application Publication
(10) Pub. No.: US 2024/0167608 A1
(43) Pub. Date: May 23, 2024

(54) LINKED CABLE-HANDLING AND CABLE-STORAGE DRUM DEVICES AND SYSTEMS FOR THE COORDINATED MOVEMENT OF A PUSH-CABLE

(71) Applicant: SeeScan, Inc., San Diego, CA (US)

(72) Inventors: Michael J. Martin, San Diego, CA (US); Alexander L. Warren, Escondido, CA (US)

(21) Appl. No.: 18/490,763

(22) Filed: Oct. 20, 2023

Related U.S. Application Data
(60) Provisional application No. 63/380,375, filed on Oct. 20, 2022.

(51) Int. Cl. F16L 55/30; F16L 55/48; F16L 101/30; H04N 23/50

(52) U.S. Cl. CPC F16L 55/30; F16L 55/48; F16L 2101/30; H04N 23/555

(57) ABSTRACT

The disclosure includes systems and devices for collaborative moving of a push-cable. Such systems and devices include cable-storage drum devices used to store and dispense/retract a push-cable, generally via motors or like machine-driven force, and cable-storage drum devices used to direct and impart machine-driven force in moving the push-cable as well as push-cable moving systems employing a cable-storage drum device and a cable-storage drum device. The cable-storage drum devices and cable-handling devices as well as systems of the present invention may be communicatively linked in generating corresponding movements of the push-cable. The disclosure further includes methods associated with such push-cable moving systems and a cleaning element apparatus that may be used in a cable-storage drum device, push-cable handling device, or both in cleaning a push-cable prior to retraction.

### CROSS-REFERENCE TO RELATED APPLICATIONS

This application claims priority under 35 U.S.C. § 119(c) to U.S. Provisional Patent Application Ser. No. 63/380,375, entitled LINKED CABLE-HANDLING AND CABLE-STORAGE DRUM DEVICES AND SYSTEMS FOR THE COORDINATED MOVEMENT OF A PUSH-CABLE, filed Oct. 20, 2022, the content of which is incorporated by reference herein in its entirety for all purposes.

### FIELD

This disclosure relates to cable-handling and cable-storage drum devices and systems used for machine-driven movement of a push-cable. More specifically, but not exclusively, the disclosure relates to motorized cable-handling and cable-storage drum devices and systems communicatively linked in generating collaborative machine-driven force on a push-cable in providing corresponding movements of the push-cable in both direction and rate.

### BACKGROUND

There are various occupations wherein a tool or other implement may need to be deployed into a pipe, cavity, or other difficult to access location. For instance, in pipe inspection systems a camera may often be needed to inspect deep within the internal area of a pipe or other cavity. Likewise, in some utility locating systems a Sonde may be deployed into a pipe or other cavity to determine a corresponding ground surface location. In such applications, a push-cable may often be employed to facilitate moving the tool or other implement in place. As known in the art, such push-cables may often be stored in a cable-storage drum and, in use, be deployed therefrom via the physical force imparted by a user. Because such operations generally require a great deal of physical strength to move the push-cable through a pipe or other void and into place, the user may be left exhausted. Further, as the interior volume of pipes may often be replete with grime, a user may be left filthy after handling a push-cable that may be moved through such a pipe.

In some operations a separate device known in the art known as a “cable-handling device” or “cable shooter” may be employed to impart machine-driven force, without the need of the user to physically impart force in moving the push-cable. Whereas such devices may save the user the exhaustion and the filth associated with physically moving the push-cable through a pipe, known cable-handling devices present a new host of problems. For instance, it may be disastrous when a push-cable is dispensed or retracted from a cable-handling device and a cable-storage drum at different rates. Wherein the push-cable is dispensed from the cable-storage drum more slowly than the cable-handling device, the cable-handling device may be suddenly jerked backwards forcing the user backwards thus risking injury. Likewise, wherein the push-cable is dispensed from the cable-storage drum at a faster rate than the cable-handling device, bunching of the push-cable may occur risking a user becoming entangled or pushed forward and risking possible injury.

Accordingly, there is a need in the art to address the above-described as well as other problems.

### SUMMARY

The present disclosure relates generally to cable-handling and cable-storage drum devices and systems used for machine-driven movement of a push-cable. More specifically, but not exclusively, the disclosure relates to motorized cable-handling and cable-storage drum devices and systems communicatively linked to generate collaborative machine-driven force on a push-cable in providing corresponding movements of the push-cable in both direction and rate.

In one aspect, the disclosure relates to a motorized cable-handling device. The cable-handling device may include a coupling element for coupling the cable-handling device about a push-cable and a drive element for imparting force in generating dispensing and retracting movements of the push-cable. Further, the cable-handling device may include a measurement element for generating measurement data relating to a measure of the amount of push-cable dispensed. An input element may be included for receiving input, which may be from a user and/or sensor information, relating to the dispensing and retracting movements of the push-cable. The cable-handling device may further include a control element having one or more processors for generating control commands relating to the dispensing and retracting forces imparted by the drive element in generating push-cable movements that correspond with the dispensing/retracting movements imparted by a cable-storage drum device. The input element may further include one or more non-transitory memories for storing instructions and data relating to push-cable movements. A communication element may be included for communicating control commands relating to the dispensing/retracting movement control with a cable-storage drum device. The cable-handling device may further include a power element for supplying of electrical power to the powered elements of the cable-handling device.

In another aspect, the present disclosure includes a motorized cable-storage drum device. The motorized cable-storage drum device may include a storage element for storing a push-cable when retracted that is further configured to dispense the push-cable. A drive element may be included for imparting force in generating dispensing and retracting movements of the push-cable. The motorized cable-storage drum device may include a measurement element for generating measurement data relating to a measure of the amount of push-cable dispensed. A control element may be included in the motorized cable-storage drum device having one or more processors for generating control commands relating to the dispensing and retracting forces imparted by the drive element in generating push-cable movements that correspond with the dispensing/retracting movements imparted by a cable-handling device and one or more non-transitory memories for storing instructions and data relating to push-cable movements. The motorized cable-storage drum device may further include a communication element for communicating control commands relating to the dispensing/retracting movement control with a cable-handling device. The cable-storage drum device may further include a power element for supplying of electrical power to the powered elements of the cable-storage drum device.

In another aspect, the present disclosure includes a push-cable moving system having both a motorized cable-handling device and a motorized cable-storage drum device of the present disclosure and includes a push-cable. The motorized cable-handling device of the push-cable moving system may include a coupling element for coupling the cable-handling device about a push-cable and a drive element for imparting force in generating dispensing and retracting movements of the push-cable. Further, the cable-handling device may include a measurement element for generating measurement data relating to a measure of the amount of push-cable dispensed. An input element may be included for receiving input, which may be from a user and/or sensor information, relating to the dispensing and retracting movements of the push-cable. The cable-handling device may further include a control element having one or more processors for generating control commands relating to the dispensing and retracting forces imparted by the drive element in generating push-cable movements that correspond with the dispensing/retracting movements imparted by a cable-storage drum device and one or more non-transitory memories for storing instructions and data relating to push-cable movements. A communication element may be included for communicating control commands relating to the dispensing/retracting movement control with a cable-storage drum device. The cable-handling device may further include a power element for supplying of electrical power to powered elements of the cable-handling device. The motorized cable-storage drum device of the motorized push-cable moving system may include a storage element for storing a push-cable when retracted that is further configured to dispense the push-cable. A drive element may be included for imparting force in generating dispensing and retracting movements of the push-cable. The motorized cable-storage drum device may include a measurement element for generating measurement data relating to a measure of the amount of push-cable dispensed. A control element may be included in the motorized cable-storage drum device having one or more processors for generating control commands relating to the dispensing and retracting forces imparted by the drive element in generating push-cable movements that correspond with the dispensing/retracting movements imparted by a cable-handling device and one or more non-transitory memories for storing instructions and data relating to push-cable movements. The motorized cable-storage drum device may further include a communication element for communicating control commands relating to the dispensing/retracting movement control with a cable-handling device. The cable-storage drum device may further include a power element for supplying of electrical power to the powered elements of the cable-storage drum device.

Additional aspects, features, and functionality are further described below in conjunction with the appended drawings.

### BRIEF DESCRIPTION OF THE DRAWINGS

The present disclosure may be more fully appreciated in connection with the following detailed description taken in conjunction with the accompanying drawings, wherein:

FIG. 1A is an illustration of a prior art pipe inspection system including a cable-handling device;

FIG. 1B is another illustration of a prior art pipe inspection system including a cable-handling device;

FIG. 2 is an illustration of a push-cable moving system including linked motorized cable-storage drum device and motorized cable-handling device;

FIG. 3 is a method for the push-cable moving systems of the present invention;

FIG. 4A is an illustration of a motorized cable-storage drum device of the present invention;

FIG. 4B is another illustration of the motorized cable-storage drum device of FIG. 4A with some internal components exposed;

FIG. 4C is a diagram of the motorized cable-storage drum device from FIG. 4A;

FIG. 4D is an illustration of a cleaning element for use with the cable-storage drum device of FIGS. 4A-4C;

FIG. 5A is an illustration of a motorized cable-handling device of the present invention;

FIG. 5B is another illustration of the motorized cable-handling device of FIG. 5A;

FIG. 5C is a diagram of the motorized cable-handling device from FIG. 5A;

FIG. 5D is an illustration of a cleaning element for use with the cable-handling device of FIGS. 5A-5C;

FIG. 6A is an illustration of a cable-storage drum device that may stow a cable-handling device;

FIG. 6B is another illustration of the cable-storage drum device that may stow a cable-handling device from FIG. 6A; and

FIG. 7 is an illustration of a push-cable moving system including linked motorized cable-storage drum device and non-motorized cable-handling device.

FIG. 8A is a side view of a motorized cable-handling device.

FIG. 8B is the embodiment from FIG. 8A with the housing removed.

FIG. 8C is an isometric view of the drive element of the embodiment of FIGS. 8A and 8B.

FIG. 9A is a side view of another motorized cable-handling device.

FIG. 9B is the embodiment from FIG. 9A with the housing removed.

FIG. 9C is an isometric view of the drive element of the embodiment of FIGS. 9A and 9B.

FIG. 10A is a side view of another motorized cable-handling device.

FIG. 10B is the embodiment from FIG. 10A with the housing removed.

FIG. 10C is an isometric view of the drive element of the embodiment of FIGS. 10A and 10B.

FIG. 11A is a side view of a motorized cable-handling device that includes a power drill.

FIG. 11B is the embodiment from FIG. 11A with the housing removed.

FIG. 11C is the embodiment from FIGS. 11A and 11B substituting a compliant mechanism for various gears, cams, cranks, and like mechanism of the drive element.

FIG. 11D is the embodiment from FIGS. 11A and 11B substituting a different compliant mechanism for various gears, cams, cranks, and like mechanism of the drive element.

### DETAILED DESCRIPTION OF EMBODIMENTS

### Overview

The present disclosure relates generally to cable-handling and cable-storage drum devices and systems used for machine-driven movement of a push-cable. More specifically, but not exclusively, the disclosure relates to motorized cable-handling and cable-storage drum devices and systems communicatively linked to generate collaborative machine-driven force on a push-cable in providing corresponding movements of the push-cable in both direction and rate.

In one aspect, the disclosure relates to a motorized cable-handling device. The cable-handling device may include a coupling element for coupling the cable-handling device about a push-cable and a drive element for imparting force in generating dispensing and retracting movements of the push-cable. The drive element may, in some embodiments, include one or more electric motors for imparting force in moving the push-cable. Further, the cable-handling device may include a measurement element for generating measurement data relating to a measure of the amount of push-cable dispensed. In some embodiments, such a measurement element may be or include optical sensors, mechanical sensors, or other sensors for measuring the amount of push-cable paid out. An input element in the motorized cable-handling device may be included for receiving input, which may be from a user and/or sensor information, relating to the dispensing and retracting movements of the push-cable. Such an input element may include but should not be limited to push-button controls, switches, triggers, microphones for audio input, or like input apparatus allowing a user to input commands that may be carried out by the device. Likewise, in some embodiments input may be generated from one or more sensors in informing the moving of the push-cable. For instance, optical and/or inertial sensors indicating a blockage in a pipe may inform the input element to halt or back up the movement of the push-cable.

In some embodiments, the input element may be located in a separate device such as a communicatively coupled smartphone, tablet, computer, other like computing device, or other system device. The cable-handling device may further include a control element having one or more processors for generating control commands relating to the dispensing and retracting forces imparted by the drive element in generating push-cable movements that correspond with the dispensing/retracting movements imparted by a cable-storage drum device and one or more non-transitory memories for storing instructions and data relating to push-cable movements. The input element may directly or indirectly couple to the one or more processors of the control element to generate control commands based on input from the user. A communication element may be included for communicating control commands relating to the dispensing/retracting movement control with a cable-storage drum device. For instance, the communication element may include but should not be limited to various wireless communication apparatus such as Bluetooth, Wi-Fi, ISM, or other radio or wireless technologies. Likewise, in some embodiments, communication may occur via wires between the cable-handling device and a cable-storage drum device. The cable-handling device may further include a power element for supplying of electrical power to powered elements of the cable-handling device. For instance, the power element may be or include one or more batteries, wired connection to grid power, or other connection to power sources that may power the cable-storage drum device.

In another aspect, the present disclosure includes a motorized cable-storage drum device. The motorized cable-storage drum device may include a storage element for storing a push-cable when retracted that is further configured to dispense the push-cable. For instance, the storage element may include a hub onto which push-cable may be wound for storage further configured to dispense the push-cable when in use. A drive element may be included for imparting force in generating dispensing and retracting movements of the push-cable. For instance, the drive element may include an electric motor to impart rotational force in spinning the hub in dispensing and retracting the push-cable. The motorized cable-storage drum device may include a measurement element for generating measurement data relating to a measure of the amount of push-cable dispensed. In some embodiments, such a measurement element may be or include optical sensors, mechanical sensors, or other sensors for measuring the amount of push-cable paid out. Likewise, in some embodiments the measurement element may include various sensors or counting apparatus to determine the amount of push-cable dispensed based on hub rotations. A control element may be included in the motorized cable-storage drum device having one or more processors for generating control commands relating to the dispensing and retracting forces imparted by the drive element in generating push-cable movements that correspond with the dispensing/retracting movements imparted by a cable-handling device and one or more non-transitory memories for storing instructions and data relating to push-cable movements. In some embodiments, the control element may fully or in part be located in one or more other wirelessly connected smartphones, tablets, laptops, or other computers or devices. The motorized cable-storage drum device may further include a communication element for communicating control commands relating to the dispensing/retracting movement control with a cable-handling device. For instance, the communication element may include but should not be limited to various wireless communication apparatus such as Bluetooth, Wi-Fi, ISM, or other radio or wireless technologies. Likewise, in some embodiments, communication may occur via wires between the cable-storage drum device and a cable-handling device. The cable-storage drum device may further include a power element for supplying of electrical power to powered elements of the cable-storage drum device. For instance, the power element may be or include one or more batteries, wired connection to grid power, or other connection to power sources that may power the cable-storage drum device.

In another aspect, the present disclosure includes a push-cable moving system having both a motorized cable-handling device and a motorized cable-storage drum device of the present disclosure and includes a push-cable. The motorized cable-handling device of the push-cable moving system may include a coupling element for coupling the cable-handling device about a push-cable and a drive element for imparting force in generating dispensing and retracting movements of the push-cable. The drive element may, in some embodiments, include one or more electric motors for imparting force in moving the push-cable. Further, the cable-handling device may include a measurement element for generating measurement data relating to a measure of the amount of push-cable dispensed. In some embodiments, such a measurement element may be or include optical sensors, mechanical sensors, or other sensors for measuring the amount of push-cable paid out. An input element in the motorized cable-handling device may be included for receiving input, which may be from a user and/or sensor information, relating to the dispensing and retracting movements of the push-cable. Such an input element may include but should not be limited to push-button controls, switches, triggers, microphones for audio input, or like input apparatus allowing a user to input commands that may be carried out by the device. Likewise, in some embodiments input may be generated from one or more sensors in informing the moving of the push-cable. For instance, optical and/or inertial sensors indicating a blockage in a pipe may inform the input element to halt or back up the movement of the push-cable. In some embodiments, the input element may be located in a separate device such as a communicatively coupled smartphone, tablet, computer, other like computing device, or other system device. The cable-handling device may further include a control element having one or more processors for generating control commands relating to the dispensing and retracting forces imparted by the drive element in generating push-cable movements that correspond with the dispensing/retracting movements imparted by a cable-storage drum device and one or more non-transitory memories for storing instructions and data relating to push-cable movements. In some embodiments, the control element may fully or in part be located in one or more other wirelessly connected smartphones, tablets, laptops, or other computers or devices. The input element may directly or indirectly couple to the one or more processors of the control element to generate control commands based on input from the user. A communication element may be included for communicating control commands relating to the dispensing/retracting movement control with a cable-storage drum device. For instance, the communication element may include but should not be limited to various wireless communication apparatus such as Bluetooth, Wi-Fi, ISM, or other radio or wireless technologies. Likewise, in some embodiments, communication may occur via wires between the cable-handling device and a cable-storage drum device. The cable-handling device may further include a power element for supplying of electrical power to powered elements of the cable-handling device. For instance, the power element may be or include one or more batteries, wired connection to grid power, or other connection to power sources that may power the cable-storage drum device.

The motorized cable-storage drum device of the push-cable moving system may include a storage element for storing the push-cable when retracted that is further configured to dispense the push-cable. For instance, the storage element may include a hub onto which the push-cable may be wound for storage on the hub thereof and further be configured to dispense the push-cable when in use. A drive element may be included for imparting force in generating dispensing and retracting movements of the push-cable. For instance, the drive element may include an electric motor to impart rotational force in spinning the hub in dispensing and retracting the push-cable. The motorized cable-storage drum device may include a measurement element for generating measurement data relating to a measure of the amount of push-cable dispensed. In some embodiments, such a measurement element may be or include optical sensors, mechanical sensors, or other sensors for measuring the amount of push-cable paid out. Likewise, in some embodiments the measurement element may include various sensors or counting apparatus to determine the amount of push-cable dispensed based on hub rotations. A control element may be included in the motorized cable-storage drum device having one or more processors for generating control commands relating to the dispensing and retracting forces imparted by the drive element in generating push-cable movements that correspond with the dispensing/retracting movements imparted by a cable-handling device and one or more non-transitory memories for storing instructions and data relating to push-cable movements. In some embodiments, the control element may fully or in part be located in one or more other wirelessly connected smartphones, tablets, laptops, or other computers or devices. The motorized cable-storage drum device may further include a communication element for communicating control commands relating to the dispensing/retracting movement control with a cable-handling device. For instance, the communication element may include but should not be limited to various wireless communication apparatus such as Bluetooth, Wi-Fi, ISM, or other radio or wireless technologies. Likewise, in some embodiments, communication may occur via wires between the cable-storage drum device and a cable-handling device. The cable-storage drum device may further include a power element for supplying of electrical power to powered elements of the cable-storage drum device. For instance, the power element may be or include one or more batteries, wired connection to grid power, or other connection to power sources that may power the cable-storage drum device

In another aspect, the cable-handling device, motorized cable-storage drum device, and push-cable moving system embodiments of the present disclosure may be employed in a pipe inspection system. Such a pipe inspection system may include but should not be limited to one or more cameras disposed on the push-cable to generate videos or images from inside the pipe or other cavity that may further be communicated to a camera control unit (CCU) or other device for displaying and controlling aspects of the camera and overall system. In some embodiments, one or more sensors may be deployed on the push-cable for collecting information corresponding to images/videos generated at the camera. For instance, such embodiments may include temperature sensors, microphones, or the like.

In another aspect, the cable-handling device, motorized cable-storage drum device, and push-cable moving system embodiments of the present disclosure may be employed in a utility locating system. In some embodiments a Sonde may be included for locating and tracing the movement location of the push-cable (which may further include a camera) through the pipe or other cavity. In some embodiments, a utility locator device may be included for determining utility line locations from magnetic fields emitted by one or more utility lines, Sonde, or the push-cable.

In another aspect, the control element of the cable-handling device embodiments, cable-storage drum device embodiments, and/or push-cable moving system embodiments of the present disclosure may be governed by measurement data from the cable-handling device, cable-storage drum device, or both. For instance, in some embodiments measurement data from the motorized cable-storage drum device and cable-handling device is compared and adjustments to the rate and direction of push-cable movements to ensure synchronous movement of the push-cable from the cable-storage drum device and cable-handling device. In some embodiments, adjusting the rate and direction of push-cable movements may occur at the cable-storage drum device. In further embodiments, adjusting the rate and direction of push-cable movements may occur at the cable-handling device. In yet further embodiments, adjusting the rate and direction of push-cable movements may occur at both the cable-storage drum device and the cable-handling device.

In another aspect, the control element of the cable-handling device embodiments, cable-storage drum device embodiments, and/or push-cable moving system embodiments of the present disclosure may have a control element and/or input element disposed in one or more wirelessly connected smartphones, tablets, laptops, or other computers or devices.

In another aspect, some cable-handling device, cable-storage drum device, and push-cable moving system embodiments of the present disclosure may include a cleaning element to wipe or clean the push-cable during dispensing or retracting movements.

In another aspect, some cable-handling device, cable-storage drum device, and push-cable moving system embodiments of the present disclosure the cable-handling device through which the push-cable may freely move and movement of the push-cable is achieved via the drive element in the motorized cable-storage drum device. In some such embodiments, the input element may be on the cable-handling device for receiving input from the user in controlling the movement of the push-cable via the drive element in the motorized cable-storage drum device. In some embodiments, an input element may additionally or instead by on the cable-storage drum device and/or on a smartphone, tablet, laptop, or other computing device or system device.

In another aspect, in some cable-handling device, cable-storage drum device, and push-cable moving system embodiments of the present disclosure the cable-handling device may be configured to stow on the cable-storage drum device.

In another aspect, the drive element of cable-handling devices and associated systems of the present invention may include a clutch mechanism to engage and disengage the drive element with a push-cable. For instance, in some such embodiments, the cable-handling device may engage a clutch mechanism with a push-cable at a first position, move the push-cable, disengage the clutch mechanism with the push-cable at a second position, and return a clutch mechanism to first position to re-engage with the push-cable in repeating the movement cycle of the push-cable.

In another aspect, the drive element of cable-handling devices and associated systems and methods of the present invention may impart forces configured to cause impulsive movements of the push-cable. For instance, the impulsive movements of the push-cable may be periodic push-cable movement with brief pauses between each instance of push-cable movement similar to the movements a user may be accustomed to when moving the push-cable by hand. Such impulsive push-cable movements may be useful in helping guide the push-cable through turns or through branches in the pipe or other void. In some such embodiments, such impulsive movement may be generated via a clutch mechanism engaging with the push-cable at a first position, move the push-cable, disengage the clutch mechanism with the push-cable at a second position, and return a clutch mechanism to first position to re-engage with the push-cable in repeating the cycle in moving the push-cable. For instance, one or more cams and/or gears, worm gear drives, or similar drive mechanisms may be configured in moving a clutch mechanism back and forth in generating such impulsive movements.

In another aspect, the drive element of cable-handling devices and associated systems of the present invention may include a power drill removably coupled to the cable-handling device. The power drill may, when in use, provide the force to indirectly move a push-cable. For instance, a power drill may couple to a port on the cable-handling device and by actuating the power drill, force may be provided in turning gears or other mechanism in the cable-handling device that may further move the push-cable.

Details of example devices, systems, and methods that may be combined with the geographic map updating system and method embodiments herein, as well as additional components, methods, and configurations that may be used in conjunction with the embodiments described herein, are disclosed in co-assigned patents and patent applications including: U.S. Pat. No. 5,808,239, issued Aug. 17, 1999, entitled VIDEO PUSH-CABLE; U.S. Pat. No. 6,545,704, issued Jul. 7, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,958,767, issued Oct. 25, 2005, entitled VIDEO PIPE INSPECTION SYSTEM EMPLOYING NON-ROTATING CABLE STORAGE DRUM; U.S. Pat. No. 6,862,945, issued Mar. 8, 2005, entitled CAMERA GUIDE FOR VIDEO PIPE INSPECTION SYSTEM; U.S. Pat. No. 7,009,399, issued Mar. 7, 2006, entitled OMNIDIRECTIONAL SONDE AND LINE LOCATOR; U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 7,221,136, issued May 22, 2007, entitled SONDES FOR LOCATING UNDERGROUND PIPES AND CONDUITS; U.S. Pat. No. 7,276,910, issued Oct. 2, 2007, entitled A COMPACT SELF-TUNED ELECTRICAL RESONATOR FOR BURIED OBJECT LOCATOR APPLICATIONS; U.S. Pat. No. 7,288,929, issued Oct. 30, 2007, entitled INDUCTIVE CLAMP FOR APPLYING SIGNAL TO BURIED UTILITIES; U.S. Pat. No. 7,298,126, issued Nov. 20, 2007, entitled SONDES FOR LOCATING UNDERGROUND PIPES AND CONDUITS; U.S. Pat. No. 7,332,901, issued Feb. 19, 2008, entitled LOCATOR WITH APPARENT DEPTH INDICATION; U.S. Pat. No. 7,336,078, issued Feb. 26, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 7,557,559, issued Jul. 7, 2009, entitled COMPACT LINE ILLUMINATOR FOR BURIED PIPES AND CABLES; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,741,848, issued Jun. 22, 2010, entitled ADAPTIVE MULTICHANNEL LOCATOR SYSTEM FOR MULTIPLE PROXIMITY DETECTION; U.S. Pat. No. 7,755,360, issued Jul. 13, 2010, entitled PORTABLE LOCATOR SYSTEM WITH JAMMING REDUCTION; U.S. Pat. No. 7,825,647, issued Nov. 2, 2010, entitled METHOD FOR LOCATING BURIED PIPES AND CABLES; U.S. Pat. No. 7,830,149, issued Nov. 9, 2010, entitled AN UNDERGROUND UTILITY LOCATOR WITH A TRANSMITTER. A PAIR OF UPWARDLY OPENING POCKET AND HELICAL COIL TYPE ELECTRICAL CORDS; U.S. Pat. No. 7,864,980, issued Jan. 4, 2011, entitled SONDES FOR LOCATING UNDERGROUND PIPES AND CONDUITS; U.S. Pat. No. 7,948,236, issued May 24, 2011, entitled ADAPTIVE MULTICHANNEL LOCATOR SYSTEM FOR MULTIPLE PROXIMITY DETECTION; U.S. Pat. No. 7,969,151, issued Jun. 28, 2011, entitled PRE-AMPLIFIER AND MIXER CIRCUITRY FOR A LOCATOR ANTENNA; U.S. Pat. No. 7,990,151, issued Aug. 2, 2011, entitled TRI-POD BURIED LOCATOR SYSTEM; U.S. Pat. No. 8,013,610, issued Sep. 6, 2011, entitled HIGH Q SELF-TUNING LOCATING TRANSMITTER; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 8,289,385, issued Oct. 16, 2012, entitled PUSH-CABLE FOR PIPE INPECTION SYSTEM; U.S. patent application Ser. No. 13/769,202, filed Feb. 15, 2013, entitled SMART PAINT STICK DEVICES AND METHODS; U.S. patent application Ser. No. 13/793,168, filed Mar. 11, 2013, entitled BURIED OBJECT LOCATORS WITH CONDUCTIVE ANTENNA BOBBINS; U.S. Pat. No. 8,395,661, issued Mar. 12, 2013, entitled PIPE INSPECTION SYSTEM WITH SELECTIVE IMAGE CAPTURE; U.S. Pat. No. 8,400,154, issued Mar. 19, 2013, entitled LOCATOR ANTENNA WITH CONDUCTIVE BOBBIN; U.S. patent application Ser. No. 14/027,027, filed Sep. 13, 2013, entitled SONDE DEVICES INCLUDING A SECTIONAL FERRITE CORE STRUCTURE; U.S. patent application Ser. No. 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 8,547,428, issued Oct. 1, 2013, entitled PIPE MAPPING SYSTEM; U.S. Pat. No. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUDLY INDICATING THE DIFFERENT LOCATIONS TO A USER; U.S. Pat. No. 8,587,648, issued Nov. 19, 2013, entitled SELF-LEVELING CAMERA HEAD; U.S. patent application Ser. No. 14/148,649, filed Jan. 6, 2014, entitled MAPPING LOCATING SYSTEMS & METHODS; U.S. Pat. No. 8,635,043, issued Jan. 21, 2014, entitled LOCATOR AND TRANSMITTER CALIBRATION SYSTEM; U.S. Pat. No. 8,717,028, issued May 6, 2014, entitled SPRING CLIPS FOR USE WITH LOCATING TRANSMITTERS; U.S. Pat. No. 8,773,133, issued Jul. 8, 2014, entitled ADAPTIVE MULTICHANNEL LOCATOR SYSTEM FOR MULTIPLE PROXIMITY DETECTION; U.S. Pat. No. 8,841,912, issued Sep. 23, 2014, entitled PRE-AMPLIFIER AND MIXER CIRCUITRY FOR A LOCATOR ANTENNA; U.S. Pat. No. 8,908,027, issued Dec. 9, 2014, entitled ASYMMETRIC DRAG FORCE BEARING FOR USE WITH A PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. Pat. No. 8,984,698, issued Mar. 24, 2015, entitled LIGHT WEIGHT SEWER CABLE; U.S. Pat. No. 9,041,794, issued May 26, 2015, entitled PIPE MAPPING SYSTEMS AND METHODS; U.S. Pat. No. 9,057,754, issued Jun. 16, 2015, entitled ECONOMICAL MAGNETIC LOCATOR APPARATUS AND METHOD; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,081,109, issued Jul. 14, 2015, entitled GROUND-TRACKING DEVICES FOR USE WITH A MAPPING LOCATOR; U.S. Pat. No. 9,080,992, issued Jul. 14, 2015, entitled ADJUSTABLE VARIABLE RESOLUTION INSPECTION SYSTEMS AND METHODS; U.S. Pat. No. 9,082,269, issued Jul. 14, 2015, entitled HAPTIC DIRECTIONAL FEEDBACK HANDLES FOR LOCATION DEVICES; U.S. Pat. No. 9,085,007, issued Jul. 21, 2015, entitled MARKING PAINT APPLICATOR FOR PORTABLE LOCATOR; U.S. Pat. No. 9,207,350, issued Dec. 8, 2015, entitled BURIED OBJECT LOCATOR APPARATUS WITH SAFETY LIGHTING ARRAY; U.S. Pat. No. 9,222,809, issued Dec. 29, 2015, entitled PORTABLE PIPE INSPECTION SYSTEMS AND APPARATUS; U.S. Pat. No. 9,341,740, issued May 17, 2016, entitled OPTICAL GROUND TRACKING APPARATUS, SYSTEMS, AND METHODS; U.S. Pat. No. 9,372,117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPATUS, SYSTEMS, AND METHODS; U.S. Pat. No. 9,411,066, issued Aug. 9, 2016, entitled SONDES & METHODS FOR USE WITH BURIED LINE LOCATOR SYSTEMS; U.S. Pat. No. 9,411,067, issued Aug. 9, 2016, entitled GROUND-TRACKING SYSTEMS AND APPARATUS; U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,465,129, issued Oct. 11, 2016, entitled IMAGE-BASED MAPPING LOCATING SYSTEM; U.S. Pat. No. 9,468,954, issued Oct. 18, 2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. Pat. No. 9,488,747, issued Nov. 8, 2016, entitled GRADIENT ANTENNA COILS AND ARRAYS FOR USE IN LOCATING SYSTEM; U.S. Pat. No. 9,494,706, issued Nov. 15, 2016, entitled OMNI-INDUCER TRANSMITTING DEVICES AND METHODS; U.S. Pat. No. 9,521,303, issued Dec. 13, 2016, entitled CABLE STORAGE DRUM WITH MOVABLE CCU DOCKING APPARATUS; U.S. patent application Ser. No. 15/846,102, filed Dec. 16, 2016, entitled SYSTEMS AND METHODS FOR ELECTRONICALLY MARKING, LOCATING AND VIRTUALLY DISPLAYING BURIED UTILITIES; U.S. patent application Ser. No. 15/866,360, filed Jan. 9, 2017, entitled TRACKABLE DISTANCE MEASURING DEVICES. SYSTEMS, AND METHODS; U.S. Pat. No. 9,927,368, issued Mar. 27, 2021, entitled SELF-LEVELING INSPECTION SYSTEMS AND METHODS; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. No. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. No. 9,599,740, issued Mar. 21, 2017, entitled USER INTERFACES FOR UTILITY LOCATORS; U.S. Pat. No. 9,625,602, issued Apr. 18, 2017, entitled SMART PERSONAL COMMUNICATION DEVICES AS USER INTERFACES; U.S. Pat. No. 9,632,202, issued Apr. 25, 2017, entitled ECONOMICAL MAGNETIC LOCATOR APPARATUS AND METHODS; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); U.S. patent application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. No. 9,638,824, issued May 2, 2017, entitled QUAD-GRADIENT COILS FOR USE IN LOCATING SYSTEMS; U.S. patent application, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. Pat. No. 9,684,090, issued Jun. 20, 2017, entitled NULLED-SIGNAL LOCATING DEVICES, SYSTEMS, AND METHODS; U.S. Pat. No. 9,696,447, issued Jul. 4, 2017, entitled BURIED OBJECT LOCATING METHODS AND APPARATUS USING MULTIPLE ELECTROMAGNETIC SIGNALS; U.S. Pat. No. 9,696,448, issued Jul. 4, 2017, entitled GROUND-TRACKING DEVICES AND METHODS FOR USE WITH A UTILITY LOCATOR; U.S. Pat. No. 9,703,002, issued Jun. 11, 2017, entitled UTILITY LOCATOR SYSTEMS & METHODS; U.S. patent application Ser. No. 15/670,845, filed Aug. 7, 2016, entitled HIGH FREQUENCY AC-POWERED DRAIN CLEANING AND INSPECTION APPARATUS & METHODS; U.S. patent application Ser. No. 15/681,250, filed Aug. 18, 2017, entitled ELECTRONIC MARKER DEVICES AND SYSTEMS; U.S. patent application Ser. No. 15/681,409, filed Aug. 20, 2017, entitled WIRELESS BURIED PIPE & CABLE LOCATING SYSTEMS; U.S. Pat. No. 9,746,572, issued Aug. 29, 2017, entitled ELECTRONIC MARKER DEVICES AND SYSTEMS; U.S. Pat. No. 9,746,573, issued Aug. 29, 2017, entitled WIRELESS BURIED PIPE AND CABLE LOCATING SYSTEMS; U.S. Pat. No. 9,769,366, issued Sep. 29, 2017, entitled SELF-GROUNDING TRANSMITTER PORTABLE CAMERA CONTROLLER FOR USE WITH PIPE INSPECTION SYSTEMS; U.S. Pat. No. 9,784,837, issued Oct. 10, 2017, entitled OPTICAL GROUND TRACKING APPARATUS, SYSTEMS & METHODS; U.S. Pat. No. 9,798,033, issued Oct. 24, 2017, entitled SONDE DEVICES INCLUDING A SECTIONAL FERRITE CORE; U.S. patent application Ser. No. 15/811,361, filed Nov. 13, 2017, entitled OPTICAL GROUND-TRACKING APPARATUS, SYSTEMS, AND METHODS; U.S. Pat. No. 9,835,564, issued Dec. 5, 2017, entitled MULTI-CAMERA PIPE INSPECTION APPARATUS, SYSTEMS, AND METHODS; U.S. Pat. No. 9,841,503, issued Dec. 12, 2017, entitled OPTICAL GROUND-TRACKING APPARATUS, SYSTEMS, AND METHODS; U.S. patent application Ser. No. 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. patent application Ser. No. 15/866,360, filed Jan. 9, 2018, entitled TRACKED DISTANCE MEASURING DEVICES, SYSTEMS, AND METHODS; U.S. patent application Ser. No. 16/255,524, filed Jan. 23, 2018, entitled RECHARGEABLE BATTERY PACK ONBOARD CHARGE STATE INDICATION METHODS AND APPARATUS; U.S. Pat. No. 9,891,337, issued Feb. 13, 2018, entitled UTILITY LOCATOR TRANSMITTER DEVICES, SYSTEMS, and METHODS WITH DOCKABLE APPARATUS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/925,643, issued Mar. 19, 2018, entitled PHASE-SYNCHRONIZED BURIED OBJECT TRANSMITTER AND LOCATOR METHODS AND APPARATUS; U.S. patent application Ser. No. 15/925,671, issued Mar. 19, 2018, entitled MULTI-FREQUENCY LOCATING SYSTEMS AND METHODS; U.S. patent application Ser. No. 15/936,250, filed Mar. 26, 2018, entitled GROUND TRACKING APPARATUS, SYSTEMS, AND METHODS; U.S. Pat. No. 9,927,545, issued Mar. 27, 2018, entitled MULTI-FREQUENCY LOCATING SYSTEMS & METHODS; U.S. Pat. No. 9,928,613, issued Mar. 27, 2018, entitled GROUND TRACKING APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 9,880,309, issued Mar. 28, 2018, entitled UTILITY LOCATOR TRANSMITTER APPARATUS & METHODS; U.S. patent application Ser. No. 16/382,136, filed Apr. 11, 2018, entitled GEOGRAPHIC MAP UPDATING METHODS AND SYSTEMS; U.S. patent application Ser. No. 15/954,486, filed Apr. 16, 2018, entitled UTILITY LOCATOR APPARATUS, SYSTEMS, AND METHODS; U.S. Pat. No. 9,945,976, issued Apr. 17, 2018, entitled UTILITY LOCATOR APPARATUS, SYSTEMS, AND METHODS; U.S. Pat. No. 9,959,641, issued May 1, 2018, entitled METHODS AND SYSTEMS FOR SEAMLESS TRANSITIONING IN INTERACTIVE MAPPING SYSTEMS; U.S. Pat. No. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORHTOGONAL ANTENNAE; U.S. patent application Ser. No. 16/443,789, filed Jun. 18, 2018, entitled MULTI-DIELECTRIC COAXIAL PUSH-CABLES AND ASSOCIATED APPARATUS; U.S. Pat. No. 10,001,425, issued Jun. 19, 2018, entitled PORTABLE CAMERA CONTROLLER PLATFORM FOR USE WITH PIPE INSPECTION SYSTEM; U.S. Pat. No. 10,009,582, issued Jun. 26, 2018, entitled PIPE INSPECTION SYSTEM WITH REPLACEABLE CABLE STORAGE DRUM; U.S. patent application Ser. No. 16/036,713, issued Jul. 16, 2018, entitled UTILITY LOCATOR APPARATUS AND SYSTEMS; U.S. Pat. No. 10,027,526, issued Jul. 17, 2018, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 10,024,994, issued Jul. 17, 2018, entitled WEARABLE MAGNETIC FIELD UTILITY LOCATOR SYSTEM WITH SOUND FIELD GENERATION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,042,072, issued Aug. 7, 2018, entitled OMNI-INDUCER TRANSMITTING DEVICES AND METHODS; U.S. Pat. No. 10,059,504, issued Aug. 28, 2018, entitled MARKING PAINT APPLICATOR FOR USE WITH PORTABLE UTILITY LOCATOR; U.S. patent application Ser. No. 16/049,699, filed Jul. 30, 2018, entitled OMNI-INDUCER TRANSMITTING DEVICES AND METHODS; U.S. Pat. No. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. patent application Ser. No. 16/121,379, filed Sep. 4, 2018, entitled KEYED CURRENT SIGNAL UTILITY LOCATING SYSTEMS AND METHODS; U.S. patent application Ser. No. 16/125,768, filed Sep. 10, 2018, entitled BURIED OBJECT LOCATOR APPARATUS AND METHODS; U.S. Pat. No. 10,073,186, issued Sep. 11, 2018, entitled KEYED CURRENT SIGNAL UTILITY LOCATING SYSTEMS AND METHODS; U.S. patent application Ser. No. 16/133,642, issued Sep. 17, 2018, entitled MAGNETIC UTILITY LOCATOR DEVICES AND METHODS; U.S. Pat. No. 10,078,149, issued Sep. 18, 2018, entitled BURIED OBJECT LOCATORS WITH DODECAHEDRAL ANTENNA NODES; U.S. Pat. No. 10,082,591, issued Sep. 25, 2018, entitled MAGNETIC UTILITY LOCATOR DEVICES & METHODS; U.S. Pat. No. 10,082,599, issued Sep. 25, 2018, entitled MAGNETIC SENSING BURIED OBJECT LOCATOR INCLUDING A CAMERA; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/160,874, filed Oct. 15, 2018, entitled TRACKABLE DIPOLE DEVICES. METHODS, AND SYSTEMS FOR USE WITH MARKING PAINT STICKS; U.S. Pat. No. 10,100,507, issued Oct. 16, 2018, entitled PIPE CLEARING CABLES AND APPARATUS; U.S. Pat. No. 10,105,723, issued Oct. 23, 2018, entitled TRACKABLE DIPOLE DEVICES. METHODS, AND SYSTEMS FOR USE WITH MARKING PAINT STICKS; U.S. patent application Ser. No. 16/222,994, filed Dec. 17, 2018, entitled UTILITY LOCATORS WITH RETRACTABLE SUPPORT STRUCTURES AND APPLICATIONS THEREOF; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/241,864, filed Jan. 7, 2019, entitled TRACKED DISTANCE MEASURING DEVICES, SYSTEMS, AND METHODS; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. patent application Ser. No. 16/810,788, filed Mar. 5, 2019, entitled MAGNETICALLY RETAINED DEVICE HANDLES; U.S. Pat. No. 10,247,845, issued Apr. 2, 2019, entitled UTILITY LOCATOR TRANSMITTER APPARATUS AND METHODS; U.S. patent application Ser. No. 16/382,136, filed Apr. 11, 2019, entitled GEOGRAPHIC MAP UPDATING METHODS AND SYSTEMS; U.S. Pat. No. 10,274,632, issued Apr. 20. 2019, entitled UTILITY LOCATING SYSTEMS WITH MOBILE BASE STATION; U.S. patent application Ser. No. 16/390,967, filed Apr. 22, 2019, entitled UTILITY LOCATING SYSTEMS WITH MOBILE BASE STATION; U.S. Pat. No. 10,288,997, issued May 14, 2019, entitled ROTATING CONTACT ASSEMBLIES FOR SELF-LEVELING CAMERA HEADS; U.S. patent application Ser. No. 29/692,937, filed May 29, 2019, entitled BURIED OBJECT LOCATOR; U.S. patent application Ser. No. 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. No. 10,317,559, issued Jun. 11, 2019, entitled GROUND-TRACKING DEVICES AND METHODS FOR USE WITH A UTILITY LOCATOR; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/455,491, filed Jun. 27, 2019, entitled SELF-STANDING MULTI-LEG ATTACHMENT DEVICES FOR USE WITH UTILITY LOCATORS; U.S. Pat. No. 10,353,103, issued Jul. 16, 2019, entitled SELF-STANDING MULTI-LEG ATTACHMENT DEVICES FOR USE WITH UTILITY LOCATORS; U.S. Pat. No. 10,371,305, issued Aug. 6, 2019, entitled DOCKABLE TRIPODAL CAMERA CONTROL UNIT; U.S. patent application Ser. No. 16/551,653, filed Aug. 26, 2019, entitled BURIED UTILITY MARKER DEVICES. SYSTEMS, AND METHODS; U.S. Pat. No. 10,401,526, issued Sep. 3, 2019, entitled BURIED UTILITY MARKER DEVICES. SYSTEMS, AND METHODS; U.S. Pat. No. 10,324,188, issued Oct. 9, 2019, entitled OPTICAL GROUND TRACKING APPARATUS, SYSTEMS, AND METHODS FOR USE WITH BURIED UTILITY LOCATORS; U.S. patent application Ser. No. 16/446,456, filed Jun. 19, 2019, entitled DOCKABLE TRIPODAL CAMERA CONTROL UNIT; U.S. patent application Ser. No. 16/520,248, filed Jul. 23, 2019, entitled MODULAR BATTERY PACK APPARATUS, SYSTEMS, AND METHODS; U.S. Pat. No. 10,371,305, issued Aug. 6, 2019, entitled DOCKABLE TRIPODAL CAMERA CONTROL UNIT; U.S. patent application Ser. No. 16/559,576, filed Sep. 3, 2019, entitled VIDEO PIPE INSPECTION SYSTEMS WITH VIDEO INTEGRATED WITH ADDITIONAL SENSOR DATA; U.S. patent application Ser. No. 16/588,834, filed Sep. 30, 2019, entitled VIDEO INSPECTION SYSTEM WITH WIRELESS ENABLED CABLE STORAGE DRUM; U.S. Pat. No. 10,440,332, issued Oct. 8, 2019, entitled INSPECTION CAMERA DEVICES AND METHODS WITH SELECTIVELY ILLUMINATED MULTISENSOR IMAGING; U.S. patent application Ser. No. 16/676,292, filed Nov. 6, 2019, entitled ROBUST IMPEDANCE CONTROLLED SLIP RINGS; U.S. Pat. No. 10,490,908, issued Nov. 26, 2019, entitled DUAL ANTENNA SYSTEMS WITH VARIABLE POLARIZATION; U.S. patent application Ser. No. 16/701,085, filed Dec. 2, 2019, entitled MAP GENERATION BASED ON UTILITY LINE POSITION AND ORIENTATION ESTIMATES; U.S. Pat. No. 10,534,105, issued Jan. 14, 2020, entitled UTILITY LOCATING TRANSMITTER APPARATUS AND METHODS; U.S. patent application Ser. No. 16/773,952, filed Jan. 27, 2020, entitled MAGNETIC FIELD CANCELING AUDIO DEVICES; U.S. patent application Ser. No. 16/780,813, filed Feb. 3, 2020, entitled RESILIENTLY DEFORMABLE MAGNETIC FIELD CORE APPARATUS AND APPLICATIONS; U.S. Pat. No. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. patent application Ser. No. 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. No. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. patent application Ser. No. 16/791,979, issued Feb. 14, 2020, entitled MARKING PAINT APPLICATOR APPARATUS; U.S. patent application Ser. No. 16/792,047, filed Feb. 14, 2020, entitled SATELLITE AND MAGNETIC FIELD SONDE APPARATUS AND METHODS; U.S. Pat. No. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,569,952, issued Feb. 25, 2020, entitled MARKING PAINT APPLICATOR FOR USE WITH PORTABLE UTILITY LOCATOR; U.S. patent application Ser. No. 16/827,672, filed Mar. 23, 2020, entitled DUAL ANTENNA SYSTEMS WITH VARIABLE POLARIZATION; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,608,348, issued Mar. 31, 2020, entitled DUAL ANTENNA SYSTEMS WITH VARIABLE POLARIZATION; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. patent application Ser. No. 17/235,507, filed Apr. 20, 2021, entitled UTILITY LOCATING DEVICES EMPLOYING MULTIPLE SPACED APART GNSS ANTENNAS; U.S. Provisional Patent Application 63/015,692, filed Apr. 27, 2020, entitled SPATIALLY AND PROCESSING-BASED DIVERSE REDUNDANCY FOR RTK POSITIONING; U.S. patent application Ser. No. 16/872,362, filed May 11, 2020, entitled BURIED LOCATOR SYSTEMS AND METHODS; U.S. patent application Ser. No. 16/882,719, filed May 25, 2020, entitled UTILITY LOCATING SYSTEMS, DEVICES, AND METHODS USING RADIO BROADCAST SIGNALS; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,677,820, issued Jun. 9, 2020, entitled BURIED LOCATOR SYSTEMS AND METHODS; U.S. patent application Ser. No. 16/902,245, filed Jun. 15, 2020, entitled LOCATING DEVICES, SYSTEMS, AND METHODS USING FREQUENCY SUITES FOR UTILITY DETECTION; U.S. patent application Ser. No. 16/902,249, filed Jun. 15, 2020, entitled USER INTERFACES FOR UTILITY LOCATORS; U.S. Provisional Patent Application 63/212,713, filed Jun. 20, 2021, entitled DAYLIGHT VISIBLE AND MULTI-SPECTRAL LASER RANGEFINDER AND ASSOCIATED METHODS AND UTIITY LOCATOR DEVICES; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,690,795, issued Jun. 23, 2020, entitled LOCATING DEVICES, SYSTEMS, AND METHODS USING FREQUENCY SUITES FOR UTILITY DETECTION; U.S. Pat. No. 10,690,796, issued Jun. 23, 2020, entitled USER INTERFACES FOR UTILITY LOCATORS; U.S. patent application Ser. No. 16/921,775, filed Jul. 6, 2020, entitled AUTO-TUNING CIRCUIT APPARATUS AND METHODS; U.S. Provisional Patent Application 63/055,278, filed Jul. 22, 2020, entitled VEHICLE-BASED UTILITY LOCATING USING PRINCIPAL COMPONENTS; U.S. patent application Ser. No. 17/397,940, filed Aug. 9, 2021, entitled INSPECTION SYSTEM PUSH-CABLE GUIDE APPARATUS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTLITITY LOCATOR INCLUDING A CAMERA; U.S. patent Ser. No. 16/995,793, filed Aug. 17, 2020, entitled UTILITY LOCATOR APPARATUS AND METHODS; U.S. Pat. No. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; U.S. Pat. No. 10,761,233, issued Sep. 1, 2020, entitled SONDES AND METHODS FOR USE WITH BURIED LINE LOCATOR SYSTEMS; U.S. Pat. No. 10,761,239, issued Sep. 1, 2020, entitled MAGNETIC SENSING BURIED UTILITY LOCATOR INCLUDING A CAMERA; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/013,831, filed Sep. 7, 2020, entitled MULTIFUNCTION BURIED UTILITY LOCATING CLIPS; U.S. patent application Ser. No. 17/014,646, filed Sep. 8, 2020, entitled INTEGRATED FLEX-SHAFT CAMERA SYSTEM AND HAND CONTROL; U.S. Pat. No. 10,777,919, issued Sep. 15, 2020, entitled MULTIFUNCTION BURIED UTILITY LOCATING CLIPS; U.S. patent application Ser. No. 17/020,487, filed Sep. 14, 2020, entitled ANTENNA SYSTEMS FOR CIRCULARLY POLARIZED RADIO SIGNALS; U.S. patent application Ser. No. 17/068,156, filed Oct. 12, 2020, entitled DUAL SENSED LOCATING SYSTEMS AND METHODS; U.S. Pat. No. 10,809,408, issued Oct. 20, 2020, entitled DUAL SENSED LOCATING SYSTEMS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 10,848,655, issued Nov. 24, 2020, entitled HEAT EXTRACTION ARCHITECTURE FOR COMPACT VIDEO CAMERA HEADS; U.S. patent application Ser. No. 17/110,273, filed Dec. 2, 2020, entitled INTEGRAL DUAL CLEANER CAMERA DRUM SYSTEMS AND METHODS; U.S. Pat. No. 10,859,727, issued Dec. 8, 2020, entitled ELECTRONIC MARKER DEVICES AND SYSTEMS; U.S. Pat. No. 10,908,311, issued Feb. 2, 2021, entitled SELF-STANDING MULTI-LEG ATTACHMENT DEVICES FOR USE WITH UTILITY LOCATORS; U.S. Pat. No. 10,928,538, issued Feb. 23, 2021, entitled KEYED CURRENT SIGNAL LOCATING SYSTEMS AND METHODS; U.S. Pat. No. 10,935,686, issued Mar. 2, 2021, entitled UTILITY LOCATING SYSTEM WITH MOBILE BASE STATION; U.S. patent application Ser. No. 17/190,400, filed Mar. 3, 2021, entitled DOCKABLE CAMERA REEL AND CCU SYSTEM; U.S. Pat. No. 10,955,583, issued Mar. 23, 2021, entitled BORING INSPECTION SYSTEMS AND METHODS; U.S. Pat. No. 9,927,368, issued Mar. 27, 2021, entitled SELF-LEVELING INSPECTION SYSTEMS AND METHODS; U.S. Pat. No. 10,976,462, issued Apr. 13, 2021, entitled VIDOE INPECTION SYSTEMS WITH PERSONAL COMMUNICATION DEVICE USER INTERFACES; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/528,956, filed Nov. 17, 2021, entitled VIDEO INSPECTION SYSTEM. APPARATUS, AND METHODS WITH RELAY MODULES AND CONNECTION PORT; U.S. patent application Ser. No. 17/541,057, filed Dec. 2, 2021, entitled COLOR-INDEPENDENT MARKER DEVICE APPARATUS, METHODS, AND SYSTEMS; U.S. patent application Ser. No. 17/541,057, filed Dec. 2, 2021, entitled VIDEO INSPECTION SYSTEM. APPARATUS, AND METHODS WITH RELAY MODULES AND CONNECTION PORTCOLOR-INDEPENDENT MARKER DEVICE APPARATUS, METHODS, AND SYSTEMS; U.S. Pat. No. 11,193,767, issued Dec. 7, 2021, entitled SMART PAINT STICK DEVICES AND METHODS; U.S. Pat. No. 11,199,510, issued Dec. 14, 2021, entitled PIPE INSPECTION AND CLEANING APPARATUS AND SYSTEMS; U.S. Provisional Patent Application 63/293,828, filed Dec. 26, 2021, entitled MODULAR BATTERY SYSTEMS INCLUDING INTERCHANGEABLE BATTERY INTERFACE APPARATUS; U.S. Pat. No. 11,209,115, issued Dec. 28, 2021, entitled PIPE INSPECTION AND/OR MAPPING CAMERA HEADS, SYSTEMS, AND METHODS; U.S. patent application Ser. No. 17/563,049, filed Dec. 28, 2021, entitled SONDE DEVICES WITH A SECTIONAL FERRITE CORE; U.S. Provisional Patent Application 63/306,088, filed Feb. 2, 2022, entitled UTILITY LOCATING SYSTEMS AND METHODS WITH FILTER TUNING FOR POWER GRID FLUCTUATIONS; U.S. patent application Ser. No. 17/687,538, filed Mar. 4, 2022, entitled ANTENNAS, MULTI-ANTENNA APPARATUS, AND ANTENNA HOUSINGS; U.S. Pat. No. 11,280,934, issued Mar. 22, 2022, entitled ELECTROMAGNETIC MARKER DEVICES FOR BURIED OR HIDDEN USE; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; MODULAR BATTERY SYSTEMS INCLUDING INTERCHANGEABLE BATTERY INTERFACE APPARATUS; U.S. patent application Ser. No. 18/162,663, filed Jan. 31, 2023, entitled UTILTY LOCATING SYSTEMS AND METHODS WITH FILTER TUNING FOR POWER GRID FLUCTUATIONS; U.S. Provisional Patent Application 63/485,905, filed Feb. 18, 2023, entitled SYSTEMS AND METHODS FOR INSPECTION ANIMATION; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,613, issued Mar. 28, 2023, entitled DOCKABLE CAMERA REEL AND CCU SYSTEM; U.S. Pat. No. 11,649,917, issued May 16, 2023, entitled INTEGRATED FLEX-SHAFT CAMERA SYSTEM WITH HAND CONTROL; U.S. Pat. No. 11,665,321, issued May 30, 2023, entitled PIPE INSPECTION SYSTEM WITH REPLACEABLE CABLE STORAGE DRUM; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,686,878, issued Jun. 27, 2023, entitled ELECTRONIC MARKER DEVICES FOR BURIED OR HIDDEN USE; U.S. Provisional Patent Application 63/524,698, filed Jul. 2, 2023, entitled FILTERING METHODS AND ASSOCIATED UTILITY LOCATOR DEVICES FOR LOCATING AND MAPPING BURIED UTILITY LINES; U.S. Provisional Patent Application 63/514,090, filed Jul. 17, 2023, entitled SMARTPHONE MAPPING APPARATUS FOR ASET TAGGING AS USED WITH UTILITY LOCATOR DEVICES; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. Pat. No. 11,719,646, issued Aug. 8, 2023, entitled PIPE MAPPING SYSTEMS AND METHODS; U.S. Pat. No. 11,719,846, issued Aug. 8, 2023, entitled BURIED UTILITY LOCATING SYSTEMS WITH WIRELESS DATA COMMUNICATION INCLUDING DETERMINATION OF CROSS COUPLING TO ADJACENT UTILITIES; U.S. patent application Ser. No. 18/233,285, filed Aug. 11, 2023, entitled BURIED OBJECT LOCATOR; U.S. patent application Ser. No. 18/236,786, filed Aug. 22, 2023, entitled MAGNETIC UTILITY LOCATOR DEVICES AND METHODS; U.S. Pat. No. 11,747,505, issued Sep. 5, 2023, entitled MAGNETIC UTILITY LOCATOR DEVICES AND METHODS; U.S. patent application Ser. No. 18/368,510, filed Sep. 14, 2023, entitled MULTIFUNCTION BURIED UTILITY LOCATING CLIPS; U.S. patent application Ser. No. 18/365,203, filed Sep. 14, 2023, entitled SYSTEMS AND METHODS FOR ELECTRONICALLY MARKING, LOCATING AND VIRTUALLY DISPLAYING BURIED UTILITIES; U.S. Pat. No. 11,768,308, issued Sep. 26, 2023, entitled SYSTEMS AND METHODS FOR ELECTRONICALLY MARKING, LOCATING AND VIRTUALLY DISPLAYING BURIED UTILITIES; U.S. Pat. No. 11,769,956, issued Sep. 26, 2023, entitled MULTIFUNCTION BURIED UTILITY LOCATING CLIPS; U.S. Pat. No. 11,782,179, issued Oct. 10, 2023, entitled BURIED OBJECT LOCATOR WITH DODECAHEDRAL ANTENNA CONFIGURATION APPARATUS AND METHODS; U.S. Pat. No. 11,789,093, issued Oct. 17, 2023, entitled THREE-AXIS MEASUREMENT MODULES AND SENSING METHODS; and U.S. Pat. No. 11,796,707, issued Oct. 24, 2023, entitled USER INTERFACES FOR UTILITY LOCATORS. The content of each of the above-described patents and applications is incorporated by reference herein in its entirety. The above applications may be collectively denoted herein as the “co-assigned applications” or “incorporated applications.”

The following exemplary embodiments are provided for the purpose of illustrating examples of various aspects, details, and functions of apparatus and systems; however, the described embodiments are not intended to be in any way limiting. It will be apparent to one of ordinary skill in the art that various aspects may be implemented in other embodiments within the spirit and scope of the present disclosure.

It is noted that as used herein, the term, “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Terminology

The terms “move” or “movements” as used herein in relation to a push-cable may refer to both dispensing movements of the push-cable (e.g., forward movement to pay out the push-cable when in use) as well as retracting movements of the push-cable (e.g., reverse movements to again store the push-cable in a cable-storage drum).

The term “push-cable” as used herein may generally refer to a semi-rigid cable, cord, wire, or like coaxial element that may be pushed or otherwise moved by a like force through an otherwise difficult to access pipe, conduit, or like void. Such a push-cable may generally provide an electromechanical connection between one or more cameras and/or like inspection devices, pipe cleaning apparatuses, Sondes or like implement(s) coupled at or near a distal end of the push-cable and camera control unit (CCU) or other apparatus at the ground surface or otherwise accessible by a user in inspecting, cleaning, locating the difficult to access location of the implement coupled to or near the distal end of the push-cable. Such push-cables must be specially designed to be flexible enough to make tight turns yet rigid enough to be pushed hundreds of feet down small diameter pipe, conduit, or like void. Examples of push-cable as used in pipe inspection and cleaning systems which may be or share aspects with the push-cables described herein are disclosed in U.S. Pat. No. 5,808,239, issued Aug. 17, 1999, entitled VIDEO PUSH-CABLE; U.S. Pat. No. 8,289,385, issued Oct. 16, 2012, entitled PUSH-CABLE FOR PIPE INPECTION SYSTEM; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,468,954, issued Oct. 18, 2016, entitled PIPE INSPECTION SYSTEM WITH JETTER PUSH-CABLE; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 16/443,789, filed Jun. 18, 2018, entitled MULTI-DIELECTRIC COAXIAL PUSH-CABLES AND ASSOCIATED APPARATUS; and U.S. Pat. No. 10,764,541, issued Sep. 1, 2020, entitled COAXIAL VIDEO PUSH-CABLES FOR USE IN INSPECTION SYSTEMS as well as others in the above incorporated applications. More broadly, a “push-cable” as discussed herein may refer to any rigid or semi-rigid similar cable or other cylindrical or tubular element that may be dispensed from a cable storage drum and directed by a cable-handling device.

The term “cable-handling devices” of the present disclosure may refer to a motorized device used generally to move one or more push-cables into a pipe or other void using machine-driven force. The cable-handling devices of the present invention may be communicatively linked with cable-storage drums to collaboratively move the push-cable. The cable-handling devices described herein may be or share aspects with those disclosed in U.S. patent application Ser. No. 17/110,273, filed Dec. 2, 2020, entitled INTEGRAL DUAL CLEANER CAMERA DRUM SYSTEMS AND METHODS as well as others in the above incorporated applications.

The “cable-storage drums” or “cable-storage drum devices” of the present disclosure may store and dispense push-cable which may have one or more attached cameras, Sondes, cleaning apparatus, or the like implement into a pipe or other void. The cable-storage drums of the present invention may be communicatively linked with cable-handling devices to collaboratively move the push-cable. The cable-storage drum devices described herein may be or share aspects with those disclosed in U.S. Pat. No. 6,958,767, issued Oct. 25, 2005, entitled VIDEO PIPE INSPECTION SYSTEM EMPLOYING NON-ROTATING CABLE STORAGE DRUM; U.S. Pat. No. 9,521,303, issued Dec. 13, 2016, entitled CABLE STORAGE DRUM WITH MOVABLE CCU DOCKING APPARATUS; U.S. Pat. No. 10,009,582, issued Jun. 26, 2018, entitled PIPE INSPECTION SYSTEM WITH REPLACEABLE CABLE STORAGE DRUM; U.S. patent application Ser. No. 16/588,834, filed Sep. 30, 2019, entitled VIDEO INSPECTION SYSTEM WITH WIRELESS ENABLED CABLE STORAGE DRUM; U.S. patent application Ser. No. 17/110,273, filed Dec. 2, 2020, entitled INTEGRAL DUAL CLEANER CAMERA DRUM SYSTEMS AND METHODS; and U.S. Pat. No. 11,558,537, issued Sep. 30, 2019, entitled VIDEO INSPECTION SYSTEM WITH WIRELESS ENABLED CABLE STORAGE DRUM as well as others in the above incorporated applications.

The “camera control unit (CCU)” of the present disclosure may display and/or store inspection video/images from the inspection camera as well as control aspects of the inspection camera and/or cleaning tool and/or aspects of the cable-reel and/or other wirelessly or wired connected devices of the pipe inspection/cleaning system. The CCUs described herein may be or share aspects with those disclosed in U.S. Pat. No. 9,521,303, issued Dec. 13, 2016, entitled CABLE STORAGE DRUM WITH MOVABLE CCU DOCKING APPARATUS; U.S. Pat. No. 9,769,366, issued Sep. 29, 2017, entitled SELF-GROUNDING TRANSMITTER PORTABLE CAMERA CONTROLLER FOR USE WITH PIPE INSPECTION SYSTEMS; U.S. Pat. No. 10,001,425, issued Jun. 19, 2018, entitled PORTABLE CAMERA CONTROLLER PLATFORM FOR USE WITH PIPE INSPECTION SYSTEM; and U.S. Pat. No. 10,371,305, issued Aug. 6, 2019, entitled DOCKABLE TRIPODAL CAMERA CONTROL UNIT as well as others in the above incorporated applications.

A “Sonde” as used herein may generally refer to a device deployed on a push-cable that may broadcast one or more radio signals for the purpose of determining the location of the Sonde (and push-cable attached thereto) at the ground surface. The Sondes described herein may be or share aspects with those disclosed in U.S. Pat. No. 7,009,399, issued Mar. 7, 2006, entitled OMNIDIRECTIONAL SONDE AND LINE LOCATOR; U.S. Pat. No. 7,221,136, issued May 22, 2007, entitled SONDES FOR LOCATING UNDERGROUND PIPES AND CONDUITS; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. patent application Ser. No. 14/027,027, filed Sep. 13, 2013, entitled SONDE DEVICES INCLUDING A SECTIONAL FERRITE CORE STRUCTURE; U.S. Pat. No. 10,761,233, issued Sep. 1, 2020, entitled SONDES AND METHODS FOR USE WITH BURIED LINE LOCATOR SYSTEMS; U.S. Pat. No. 11,187,822, issued Nov. 30, 2021, entitled SONDE DEVICES INCLUDING A SECTIONAL FERRITE CORE STRUCTURE; U.S. patent application Ser. No. 17/563,049, filed Dec. 28, 2021, entitled SONDE DEVICES WITH A SECTIONAL FERRITE CORE; and U.S. Pat. No. 11,709,289, issued Jul. 25, 2023, entitled SONDE DEVICES WITH A SECTIONAL FERRITE CORE as well as others in the above incorporated applications.

The “utility locator devices” of the present disclosure may, for instance, be carried by a user traversing an area, or alternatively attached to a vehicle and moved about the locate area, to measure magnetic signals in order to determine the positions of and map utility lines which may generally be buried underground. Likewise, such a utility locator device may receive the signal emitted by a Sonde in determining the Sonde's location at the ground surface. The utility locator device also referred to as “line locator” or “locator” described herein may be or share aspects with those disclosed in U.S. Pat. No. 7,009,399, issued Mar. 7, 2006, entitled OMNIDIRECTIONAL SONDE AND LINE LOCATOR; U.S. Pat. No. 7,332,901, issued Feb. 19, 2008, entitled LOCATOR WITH APPARENT DEPTH INDICATION; U.S. Pat. No. 7,336,078, issued Feb. 26, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 10,670,766, issued Jun. 2, 2020, entitled UTILITY LOCATING SYSTEMS, DEVICES, AND METHODS USING RADIO BROADCAST SIGNALS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTLITITY LOCATOR INCLUDING A CAMERA; U.S. patent Ser. No. 16/995,793, filed Aug. 17, 2020, entitled UTILITY LOCATOR APPARATUS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 11,579,331, issued Feb. 14, 2023, entitled MAGNETIC SENSING BURIED UTLITITY LOCATOR INCLUDING A CAMERA; as well as others in the above incorporated applications.

In some uses, a “utility locating transmitter” may be used to couple current onto one or more utility lines for the purpose of generating the magnetic signals sensed by utility locator devices in order to determine the positions and map utility lines. The utility locating transmitter also referred to as “transmitter” described herein may be or share aspects with those disclosed in U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; and U.S. Pat. No. 10,845,497, issued Nov. 24, 2020, entitled PHASE-SYNCHRONIZED BURIED OBJECT TRANSMITTER AND LOCATOR METHODS AND APPARATUS as well as others in the above incorporated applications.

As used herein, the terms “compliant mechanism” or “flexure mechanism” is one that achieves force and motion transmission through elastic body transformation. Specifically, such a compliant mechanism may be used to grasp, move, or both grasp and move the push-cable through elastic body transformations

Additional disclosure regarding pipe inspections which may utilize a pipe-moving system of the present disclosure as well as the related push-cables, utility locator devices, utility locating transmitters, CCUs, cable-storage drums, cable-handling devices, and the like may be found in the incorporated patents and patent applications herein.

### Example Linked Cable-Handling and Cable-Storage Drum Devices and System Embodiments

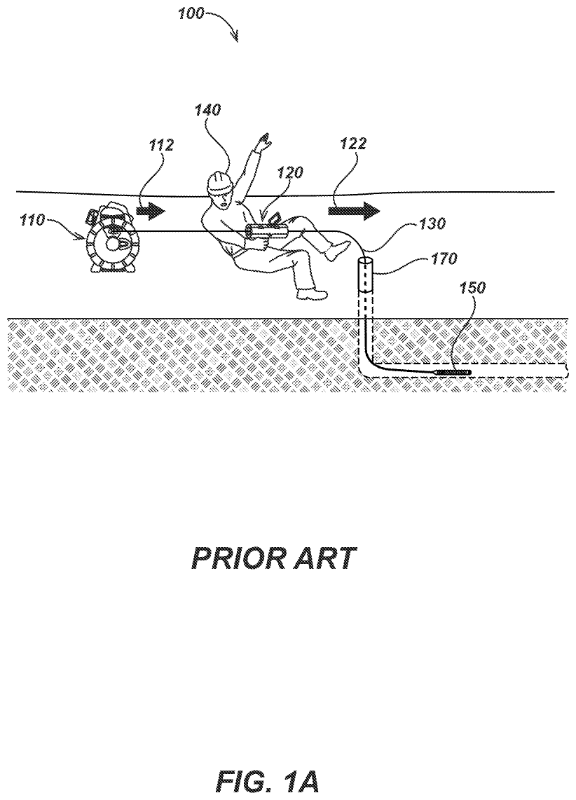

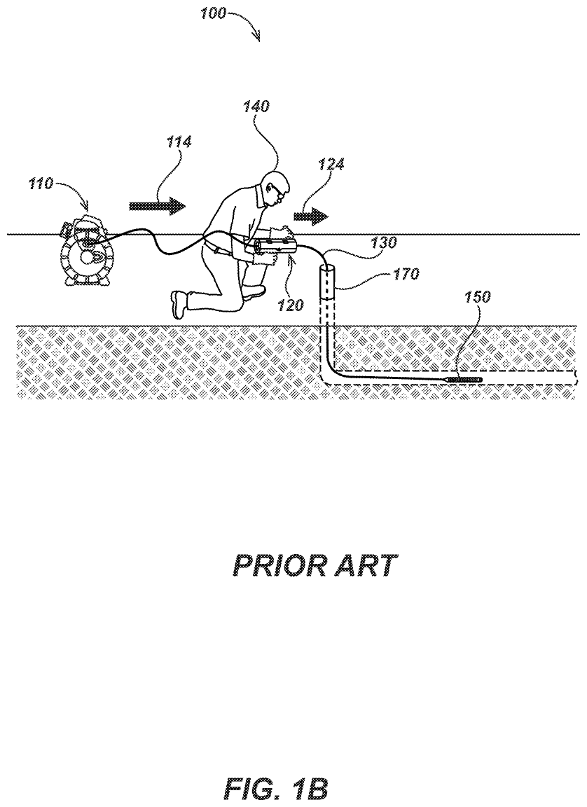

Referring to FIGS. 1A and 1B, a prior art pipe inspection system 100 is illustrated employing a cable-storage drum 110 and a cable-handling device 120 for moving a push-cable 130. As illustrated, a user 140 may steer the cable-handling device 120 in moving the push-cable 130 having a camera 150 coupled thereto through a pipe 170 or other void. Video, still images, and/or data may be communicated with and displayed upon a camera control unit (CCU) 160 or like device to display and control aspects of the pipe inspection system 100. In most known prior art systems for moving a push-cable, the force imparted to move the push-cable may come solely from the cable-handling device and not the cable-storage drum. For instance, in the prior art pipe inspection system 100 the cable-handling device 120 may include one or more motors to impart force in moving the push-cable 130 whereas the cable-storage drum 110 may lack a motor or other capacity to provide machine-driven force in moving the push-cable 130. As such, known systems lack the capacity to ensure corresponding movement of the push-cable. Because known systems, such as the prior art pipe inspection system 100, lack the capacity to ensure corresponding movement of the push-cable, problems are likely to occur wherein push-cable is dispensed or retracted from a cable-handling device and a cable-storage drum at different rates.

As illustrated in FIG. 1A, wherein the push-cable 130 is dispensed from the cable-storage drum 110 at a slower rate than the cable-handling device 120, the prior art pipe inspection system 100 may experience problems that may be hazardous to the user 140. For instance, the cable-storage drum 110 may dispense the push-cable 130 at a rate 112 and the cable-handling device 120 may dispense the push-cable 130 at a rate 122. Wherein rate 112 is slower than rate 122, the cable-handling device 120 may be forced backwards thus yank the user 140 backwards risking injury.

Turning to FIG. 1B, wherein the push-cable 130 is dispensed from the cable-storage drum 110 at a faster than the cable-handling device 120, the prior art pipe inspection system 100 may likewise experience problems that may be hazardous to the user 140. For instance, the cable-storage drum 110 may dispense the push-cable 130 at a rate 114 and the cable-handling device 120 may dispense the push-cable 130 at a rate 124. Wherein rate 114 is faster than rate 124, the push-cable 130 may bunch between the cable-handling device 120 and the cable-storage drum 110 risking the user 140 becoming entangled and possible injury.

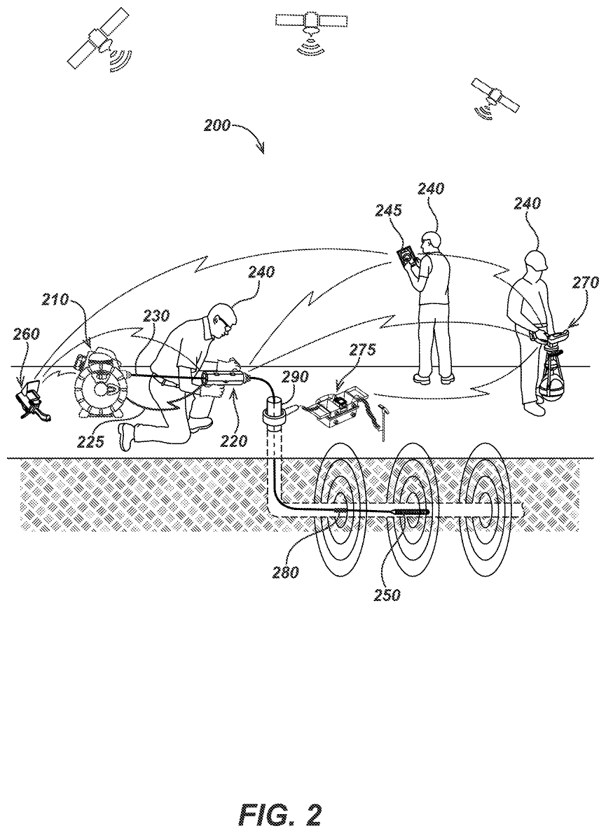

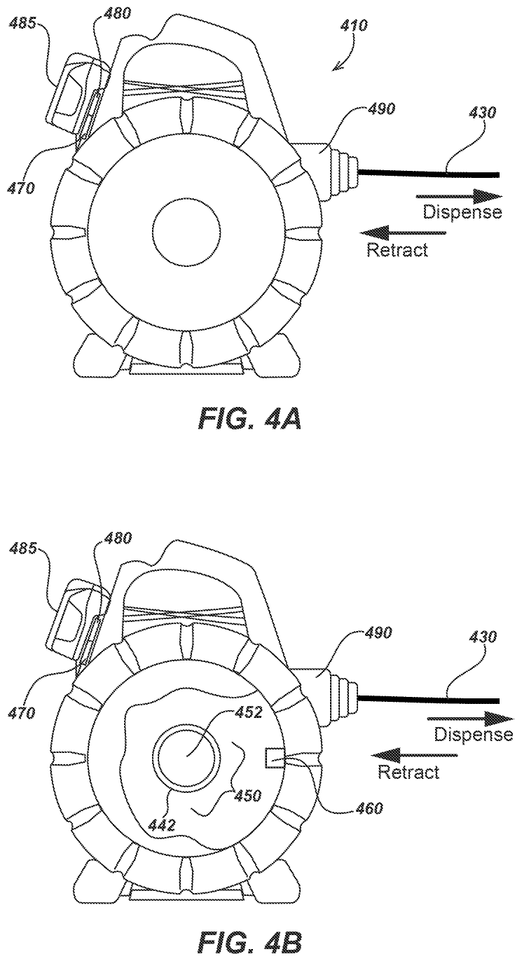

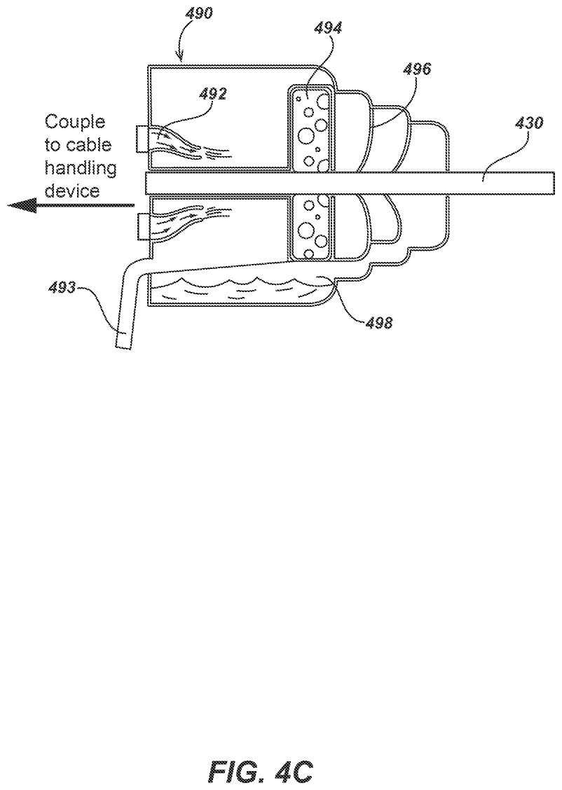

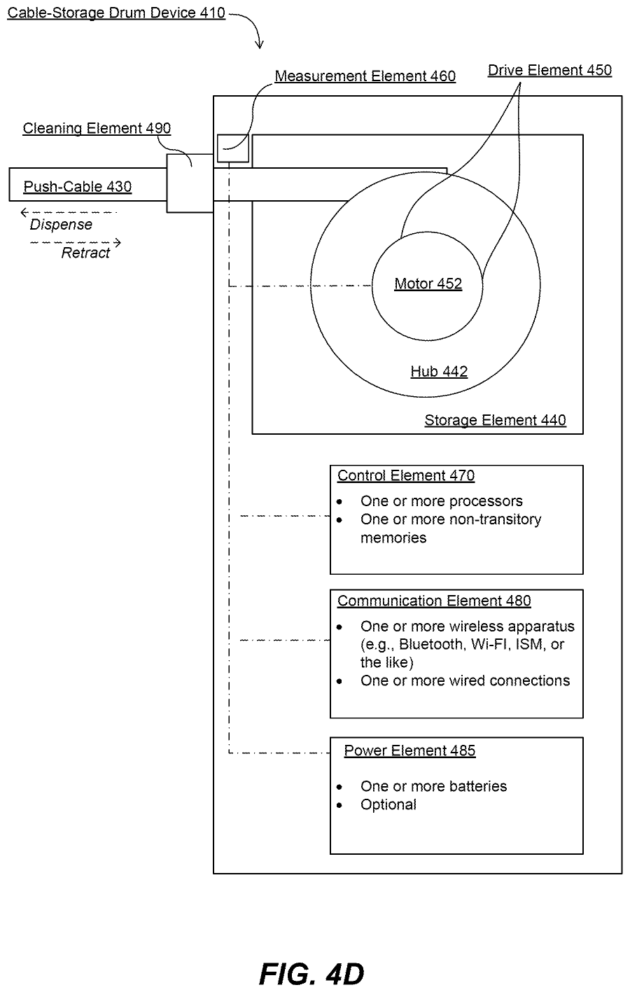

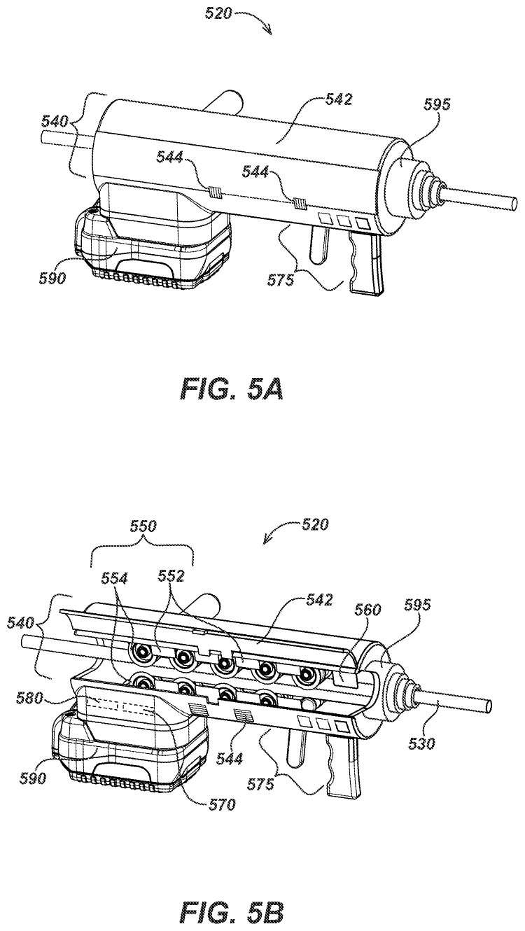

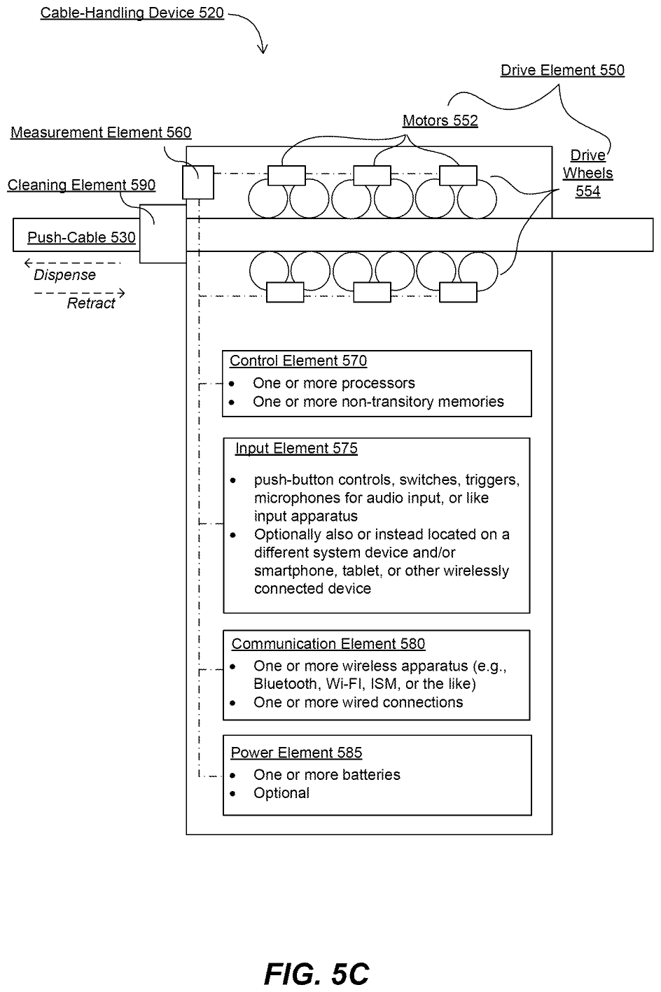

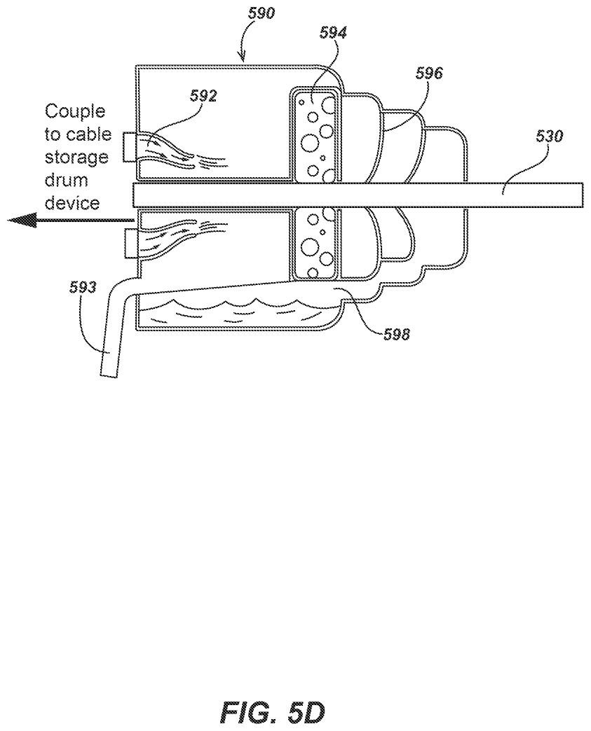

Referring to FIG. 2, a push-cable moving system 200 in keeping with the present disclosure is illustrated which may include a motorized cable-storage drum device 210 and a motorized cable-handling device 220 configured for the collaborative moving of a push-cable 230. The cable-storage drum device 210 and cable-handling device 220 may be communicatively linked (e.g., via a communication link 225) such that force imparted by the cable-storage drum device 210 and cable-handling device 220 may be collaborative in generating corresponding movements of the push-cable 230 in both direction and rate. For instance, a measurement element in both the cable-storage drum device 210 and cable-handling device 220 (e.g., the measurement element 460 of FIGS. 4B and 4C or the measurement element 560 of FIGS. 5B and 5C) may measure the amount of push-cable 230 dispensed therefrom, communicate measurement data, and adjust in real-time or near real-time such that the cable-storage drum device 210 and cable-handling device 220 may collaborate in generating corresponding movements of the push-cable 230.

Still referring to FIG. 2, input element or controls for the push-cable moving system 200 may be located on the cable-handling device 220 such that a user 240 may input commands (e.g., via push-button controls, switches, triggers, microphones for audio input, or like input element such as the input element 575 of FIGS. 5B and 5C). Control commands may be generated based on input commands via a control element having one or more processors and associated non-transitory memories (e.g., the control element 570 of FIGS. 5B and 5C) that may further shared with the cable-handling device 220 via a communication link 225. In some embodiments, such an input element and/or control element may be additionally or instead be disposed in one or more wirelessly connected smartphones (e.g., a smartphone 245), tablets, laptops, or other computers or devices including other system devices (e.g., the cable-handling device 220, the CCU 260, the utility locator device 270, the transmitter device 275, or the like). In some embodiments, such control commands may be generated via a suite of sensors present at the distal end of a push-cable (e.g., accelerometer, gyroscopic sensors, compass sensors, other inertial sensors or arrays of sensors, image recognition of objects where a camera is present, and the like) to inform movements of the push-cable.

Still referring to FIG. 2, the push-cable moving system 200 may be employed for use in a pipe inspection system having a camera 250 and a CCU 260 and/or other display/control device 265 (e.g., the smartphone 245, tablet, other computing device, utility locator such as the utility locator device 270, and/or other system device) to display and/or control aspects of the pipe inspection and various devices thereof. The various pipe inspection devices and systems including cable storage drums (e.g., the cable-storage drum device 210), cable-handling device 220, push-cables (e.g., the push-cable 230), CCUs (e.g., the CCU 260) and/or associated devices, apparatus, systems, and methods may share aspects with those disclosed in U.S. Pat. No. 9,521,303, issued Dec. 13, 2016, entitled CABLE STORAGE DRUM WITH MOVEABLE CCU DOCKING APPARATUS; U.S. patent application Ser. No. 17/110,273, filed Dec. 2, 2020, entitled INTEGRAL DUAL CLEANER CAMERA DRUM SYSTEMS AND METHODS; U.S. patent application Ser. No. 17/190,400, filed Mar. 3, 2021, entitled DOCKABLE CAMERA REEL AND CCU SYSTEM; U.S. Provisional Patent Application 63/227,974, filed Jul. 30, 2021, entitled INWARD SLOPED DRUM FACE FOR PIPE INSPECTION SYSTEMS; U.S. patent application Ser. No. 17/528,956, filed Nov. 17, 2021, entitled VIDEO INSPECTION SYSTEM, APPARATUS, AND METHODS WITH RELAY MODULES AND CONNECTION PORT; U.S. patent application Ser. No. 17/815,387, filed Jul. 27, 2022, entitled INWARD SLOPED DRUM FACE FOR PIPE INSPECTION SYSTEMS; U.S. Pat. No. 11,614,613, issued Mar. 28, 2023, entitled DOCKABLE CAMERA REEL AND CCU SYSTEM; as well as that disclosed in other patents and applications of the above incorporated patents and applications.

Still referring to FIG. 2, the push-cable moving system 200 may likewise be employed for use in a utility locating system that may include, for instance, a utility locator device 270 configured to determine utility line locations from magnetic fields emitted by one or more utility lines, a Sonde such as a Sonde 280, and/or a push-cable such as the push-cable 230. A transmitter device 275 may, for instance, couple current onto a pipe 290 or other utility line(s) causing an electromagnetic signal to be emitted therefrom that may be received at the utility locator device 270 in determining the position and mapping the pipe 290 or other utility line(s). Likewise, the Sonde 280 on push-cable 230 may emit radio signal(s) that may be received by the utility locator device 270 in determining position and mapping pipe 290 or other utility line(s). The utility locator device (e.g., utility locator device 270), as well as transmitter devices (e.g., the transmitter device 275), Sondes (e.g., Sonde 280), and/or other related utility locating devices, systems, and methods may be or share aspects with those disclosed in U.S. Pat. No. 7,864,980, issued Jan. 4, 2011, entitled SONDES FOR LOCATING UNDERGROUND PIPES AND CONDUITS; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 10,078,149, issued Sep. 18, 2018, entitled BURIED OBJECT LOCATORS WITH DODECAHEDRAL ANTENNA NODES; U.S. Pat. No. 9,891,337, issued Feb. 13, 2018, entitled UTILITY LOCATOR TRANMITTER DEVICES, SYSTEMS, AND METHODS WITH DOCKABLE APPARATUS; U.S. Pat. No. 9,927,546, issued Mar. 27, 2018, entitled PHASE-SYNCHRONIZED BURIED OBJECT TRANSMITTER AND LOCATOR METHODS AND APPARATUS; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Provisional Patent 63/115,009, filed Nov. 17, 2020, entitled SIGNAL TRANSMITTER CONNECTION PORT FOR WIRELESS INSPECTION AND LOCATING SYSTEM; U.S. patent application Ser. No. 17/528,956, filed Nov. 17, 20210, entitled VIDEO INSPECTION SYSTEM APPARATUS AND METHODS WITH RELAY MODULES AND CONNECTION PORTS; and U.S. Pat. No. 11,196,181, issued Dec. 7, 2021, entitled LOW COST, HIGH PERFORMANCE SIGNAL PROCESSING IN A MAGNETIC-FIELD SENSING BURIED UTILITY LOCATOR SYSTEM as well as that disclosed in other patents and applications of the above incorporated patents and applications.

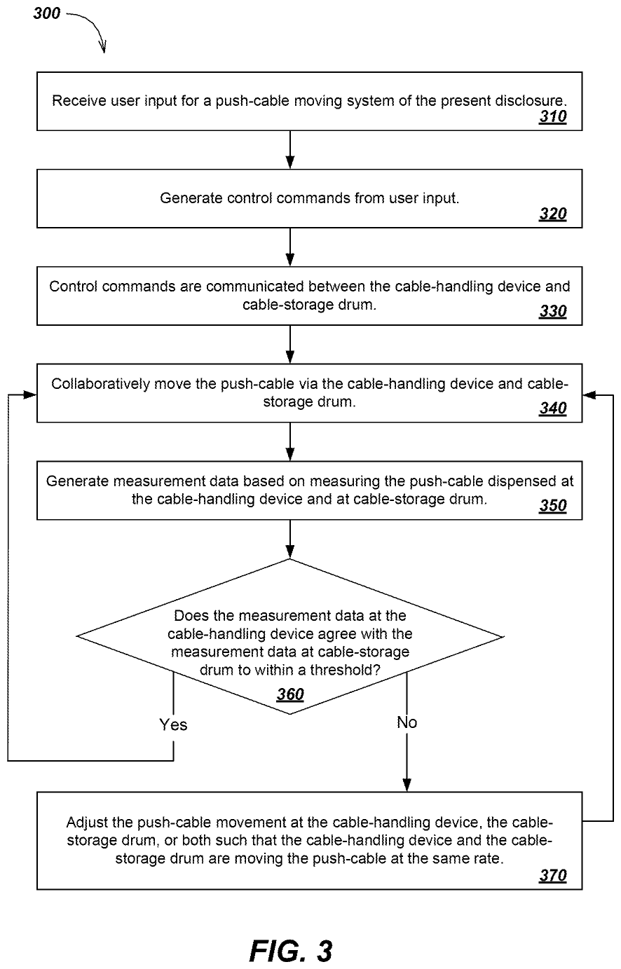

Turning to FIG. 3, a method 300 is disclosed for achieving corresponding movement of push-cable via a push-cable moving system of the present disclosure (e.g., the push-cable moving system 200 and/or other systems disclosed herein). In a step 310, user input may be received for a push-cable moving system of the present disclosure. For instance, a user may input commands through push-button controls, switches, triggers, microphones for audio input, or like input element allowing a user to input commands. Such an input element may be located at the cable-handling device. In some embodiments, such an input element may instead or additionally be located in the cable-storage drum, other systems device, a smartphone, tablet, computer, and/or other device. In a step 320, control commands may be generated. For instance, one or more processing elements and associated non-transitory memories directly or indirectly coupled to the input element in the cable-handling device may generate control commands relating to the dispensing and retracting forces imparted by drive elements in the cable-storage drum and cable-handling device for generating corresponding push-cable movements. Likewise, generating of such control commands may occur in other device having the input element or other communicatively coupled device. In a step 330, control commands may be communicated between the cable-handling device and the cable-storage drum. For instance, communication elements (e.g., wires between the cable-handling device and the cable-storage drum or wireless communication apparatus such as Bluetooth, Wi-Fi, ISM, or other radio or wireless technologies). In some embodiments, control commands may be generated via a suite of sensors present at the distal end of a push-cable (e.g., accelerometer, gyroscopic sensors, compass sensors, other inertial sensors or arrays of sensors, image recognition of objects where a camera is present, and the like) to inform movements of the push-cable. In a step 340, the cable-handling device and the cable-storage drum may collaboratively move the push-cable. For instance, drive elements in both the cable-handling device and the cable-storage drum may impart force in generating corresponding movements of the push-cable. The drive elements may, for instance, each include one or more electric motors powered by one or more batteries and/or other like apparatus in imparting force in moving the push-cable powered by one or more like power sources. In a step of 350, a decision must be made as to whether the measurement data at the cable-handling device and the cable-storage drum agree. If the measurement data at the cable-handling device and the cable-storage drum do agree, the method 300 may repeat back at step 340 wherein the cable-handling device and the cable-storage drum may collaboratively move the push-cable. If the measurement data at the cable-handling device and the cable-storage drum do not agree, the method 300 may continue on to step 370 wherein push-cable movement may be adjusted at the cable-handling device, the cable-storage drum, or both such that the cable-handling device and the cable-storage drum are moving the push-cable at the same rate. The method 300 may repeat upon different user input is received at step 310.

Turning to FIGS. 4A-4C, a motorized cable-storage drum device 410 is illustrated which may be or share aspects with the cable-storage drum device 210 of FIG. 2 as well as other cable-storage drum devices disclosed herein. For instance, the cable-storage drum device 410 may be configured for the collaborative moving of a push-cable, such as the push-cable 430, with a motorized cable-handling device (e.g., the cable-handling device 220 of FIG. 2 or the motorized cable-handling device 520 of FIGS. 5A-5C).

Turning to FIGS. 4B and 4C, the cable-storage drum device 410 may include a storage element 440 for storing the push-cable 430 when retracted that may further be configured to dispense the push-cable 430 when in use. For instance, the storage element 440 may include a hub 442 onto which the push-cable 430 may be wound for storage or dispensed from when in use.

A drive element 450 may be included for imparting force in generating dispensing and retracting movements of the push-cable 430. For instance, the drive element may include one or more electric motors 452 to impart rotational force in spinning the hub in dispensing and retracting the push-cable 430. The motorized cable-storage drum device may include a measurement element 460 for generating measurement data relating to a measure of the amount of push-cable 430 dispensed. In some embodiments, such a measurement element 460 may be or include optical sensors, mechanical sensors, or other sensors for measuring the amount of push-cable 430 paid out. Likewise, in some embodiments the measurement element 460 may include various sensors or counting apparatus to determine the amount of push-cable 430 dispensed based on hub 442 rotations. The measurement element 460 may be or include those as disclosed in U.S. Pat. No. 8,970,211, issued Mar. 3, 2015, entitled PIPE INSPECTION CABLE COUNTER AND OVERLAY MANAGEMENT SYSTEM; U.S. Pat. No. 10,527,402, issued Jan. 7, 2020, entitled PIPE INSPECTION CABLE COUNTER AND OVERLAY MANAGEMENT SYSTEM; and/or other devices and methods of the incorporated patents and applications for counting push-cable.

A control element 470 may be included in the motorized cable-storage drum device 410 having one or more processors for generating control commands relating to the dispensing and retracting forces imparted by the drive element 450 in generating push-cable 430 movements that correspond with the dispensing/retracting movements imparted by a cable-handling device (e.g., the cable-handling device 220 of FIG. 2 or the motorized cable-handling device 520 of FIGS. 5A-5C). The control element 470 may further include one or more non-transitory memories for storing instructions and data relating to push-cable 430 movements. In some embodiments, the control element 470 may fully or in part be located in one or more other wirelessly connected smartphones, tablets, laptops, or other computers or devices.

The motorized cable-storage drum device 410 may further include a communication element 480 for communicating control commands relating to the dispensing/retracting movement control with a cable-handling device (e.g., the cable-handling device 220 of FIG. 2 or the motorized cable-handling device 520 of FIGS. 5A-5C). For instance, the communication element 480 may include various wireless communication apparatus such as Bluetooth, Wi-Fi, ISM, or other radio or wireless technologies. In some embodiments a communication element may include a wired connection between the cable-storage drum device and a cable-handling device.

The cable-storage drum device 410 may further include a power element 485 for supplying of electrical power to powered elements of the cable-storage drum device. For instance, the power element 485 may be or include one or more batteries, wired connection to grid power, or other connection to power sources that may power the cable-storage drum device. The power element 485 may be or include batteries as disclosed in U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER and/or other batteries of the incorporated patents and applications. Optionally, the cable-storage drum device 410 may include a cleaning element apparatus 490.

Turning to FIG. 4D, the cleaning element apparatus 490 is shown in detail. As illustrated, the cleaning element apparatus 490 may include a Venturi/blower apparatus 492 that may create a vacuum and/or blowing force in removing water, dirt, or the like in cleaning the push-cable 430. In some embodiments, a drip path element 493 may provide a pathway by which the water, dirt, and/or other removed substances may flow to a drain and/or other reservoir helping to prevent dirtying the cable-storage device 410. In some such embodiments such a drip path as the drip path element 493 as well as drain and/or reservoir (similar to the collection element 498) may be partially or fully formed or included in the cable-storage drum 410. The cleaning element apparatus 490 may further include one or more sponges 494, squeegees 496, and/or other like elements to wipe or otherwise clean the push-cable 430. In some embodiments, a collection element 498 may be included to collect the run off from cleaning the push-cable 430 to avoid contaminating the local environment and/or testing of fluids collected from in the pipe (e.g., wastewater epidemiological testing, other wastewater analysis, or the like). Other embodiments of a cleaning element may include other instruments and apparatus in other configurations to clean the push-cable 430.

Turning to FIGS. 5A-5C, a motorized cable-handling device 520 is illustrated which may be or share aspects with the cable-handling device 220 of FIG. 2 as well as other cable-handling devices disclosed herein. For instance, the cable-handling device 520 may be configured for the collaborative moving of a push-cable, such as the push-cable 530, with a motorized cable-storage drum device (e.g., the cable-storage drum device 210 of FIG. 2 or the cable-storage drum device 420 of FIGS. 4A-4C)

Turning to FIGS. 5A and 5B, the motorized cable-handling device 520 may include a coupling element 540 for coupling the cable-handling device 520 about the push-cable 530. For instance, a door 542 having latches 544 may open allowing the cable-handling device 520 to be placed about the push-cable 530. The door 542 may again be closed and secured by latches 544 with the push-cable 530 inside. Other embodiments may include other coupling elements for securing a cable-handling device about a push-cable. For instance, in some embodiments the push-cable may not need a door, such as the door 542, as the push-cable may simply be fed through the cylindrical cavity of the cable-handling device.

Turning to FIGS. 5B and 5C, the motorized cable-handling device 520 may include a drive element 550 for imparting force in generating dispensing and retracting movements of the push-cable 530. The drive element 550 may, in some embodiments, include one or more electric motors 552 for imparting force in moving the push-cable 530. For instance, illustrated in FIG. 5B, the motors 552 may turn a number of drive wheels 554. A clutch (not illustrated) may engage the drive wheels 554 with the push-cable 530 in imparting the force to move the push-cable 530. Further, the cable-handling device 520 may include a measurement element 560 for generating measurement data relating to a measure of the amount of push-cable 530 dispensed. In some embodiments, such a measurement element may be or include optical sensors, mechanical sensors, or other sensors for measuring the amount of push-cable paid out. The measurement element 560 may be or include those as disclosed in U.S. Pat. No. 8,970,211, issued Mar. 3, 2015, entitled PIPE INSPECTION CABLE COUNTER AND OVERLAY MANAGEMENT SYSTEM; U.S. Pat. No. 10,527,402, issued Jan. 7, 2020, entitled PIPE INSPECTION CABLE COUNTER AND OVERLAY MANAGEMENT SYSTEM; and/or other devices and methods of the incorporated patents and applications for counting push-cable.

The cable-handling device 520 may further include a control element 570 having one or more processors for generating control commands relating to the dispensing and retracting forces imparted by the drive element 550 in generating push-cable 530 movements that correspond with the dispensing/retracting movements imparted by a cable-storage drum device (e.g., the cable-storage drum device 210 of FIG. 2 or the cable-storage drum device 420 of FIGS. 4A-4C) and one or more non-transitory memories for storing instructions and data relating to push-cable 530 movements. In some embodiments, the control element 570 may fully or in part be located in one or more other wirelessly connected smartphones, tablets, laptops, or other computers or devices.

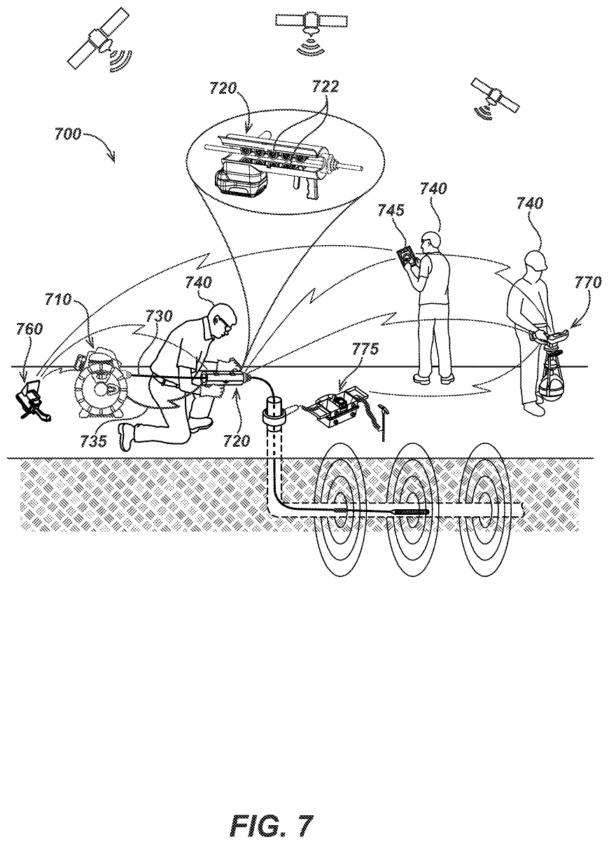

An input element 575 may directly or indirectly couple to the one or more processors of the control element 570 to generate control commands based on input from the user. The input element 575 may be or include, but should not be limited to, push-button controls, switches, triggers, microphones for audio input, or like input apparatus allowing a user to input commands that may be carried out by the device. Additional input elements may additionally or instead be located on a smartphone (e.g., a smartphone 245 of FIG. 2), tablets, laptops, or other computers or devices including other system devices such as a cable-storage drum device (e.g., the cable-storage drum device 210 of FIG. 2, the cable-storage drum device 410 of FIGS. 4A-4C, the cable-storage drum device 710 of FIG. 7, and/or others disclosed herein), a CCU (the CCU 260 of FIG. 2 or the CCU 760 of FIG. 7), a utility locator device (e.g., the utility locator device 270 of FIG. 2 or the utility locator device 770 of FIG. 7, a transmitter device (e.g., the transmitter device 275 of FIG. 2 or the transmitter device 775 of FIG. 7), or the like. For instance, the user input may occur via a trigger, push buttons, voice control mechanisms, and/or other actuators for receiving commands from a user. Likewise, in some embodiments, such control commands may be generated via a suite of sensors present at the distal end of a push-cable (e.g., accelerometer, gyroscopic sensors, compass sensors, other inertial sensors or arrays of sensors, image recognition of objects where a camera is present, and the like) to inform movements of the push-cable.

A communication element 580 may be included for communicating control commands relating to the dispensing/retracting movement control with a cable-storage drum device (e.g., the cable-storage drum device 210 of FIG. 2 or the cable-storage drum device 420 of FIGS. 4A-4C). For instance, the communication element 580 may include various wireless communication apparatus such as Bluetooth, Wi-Fi, ISM, or other radio or wireless technologies. In some embodiments the communication element 580 may instead or additionally include wires between the cable-handling device 520 and a cable-storage drum device (e.g., the cable-storage drum device 210 of FIG. 2 or the cable-storage drum device 420 of FIGS. 4A-4C). The cable-handling device 520 may further include a power element 585 for supplying of electrical power to powered elements of the cable-handling device 520. For instance, the power element 585 may be or include one or more batteries, wired connection to grid power, or other connection to power sources that may power the cable-storage drum device. The power element 585 may be or include batteries as disclosed in U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER and/or other batteries of the incorporated patents and applications. Optionally, the cable-handling device 520 may include a cleaning element apparatus 590.

Turning to FIG. 5D, the cleaning element apparatus 590 is shown in detail which may be or share aspects with the cleaning element apparatus 490 of FIG. 4D or other cleaning element apparatus disclosed herein adapter for a cable-handling device. As illustrated, the cleaning element apparatus 590 may include a Venturi/blower apparatus 592 that may create a vacuum and/or blowing force in removing water, dirt, or the like in cleaning the push-cable 530. In some embodiments, a drip path element 593 may provide a pathway by which the water, dirt, and/or other removed substances may flow to a drain and/or other reservoir helping to prevent dirtying the cable-handling device 520. In some such embodiments such a drip path as the drip path element 593 as well as drain and/or reservoir (similar to the collection element 598) may be partially or fully formed or included in the cable-handling device 520. The cleaning element apparatus 590 may further include one or more sponges 594, squeegees 596, and/or other like elements to wipe or otherwise clean the push-cable 530. In some embodiments, a collection element 598 may be included to collect the run off from cleaning the push-cable 530 to avoid contaminating the local environment and/or testing of fluids collected from in the pipe (e.g., wastewater epidemiological testing, other wastewater analysis, or the like). Other embodiments of a cleaning element may include other instruments and apparatus in other configurations to clean the push-cable 530.

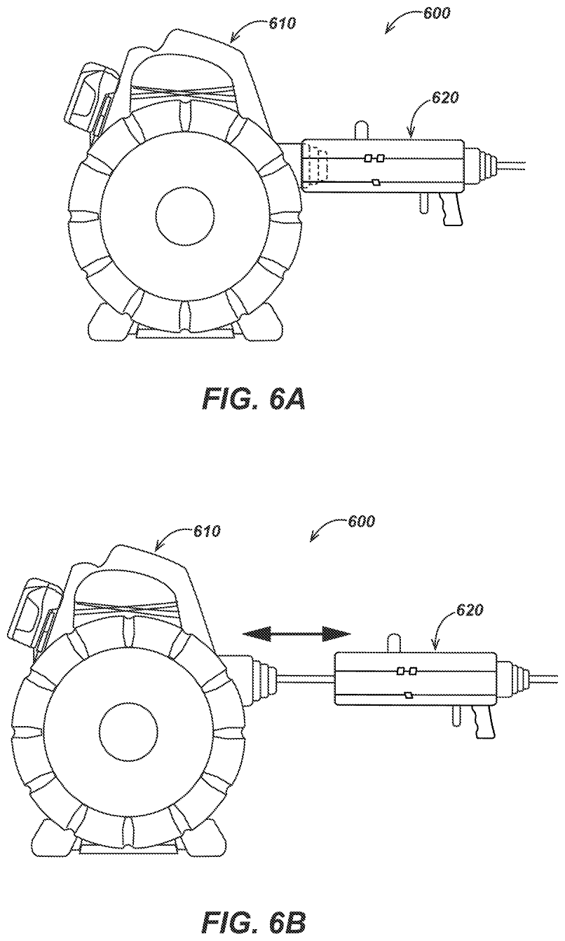

In some pipe-moving systems in keeping with the present disclosure, the cable-handling device may be configured to stow onto the cable-drum reel device. Turning to FIGS. 6A and 6B, a pipe-moving system 600 in keeping with the present disclosure may include a cable-storage drum device 610 which may be configured to stow a cable-handling device 620. The push-cable moving system 600, the cable-storage drum device 610, and/or cable-handling device 620 may be or share aspects with the pipe-moving system 200, the cable-storage drum device 210, and/or the cable-handling device 220 of FIG. 2 and/or the cable-storage drum device 410 of FIGS. 4A-4C, and/or the cable-handling device 520 of FIGS. 5A-5C.

As best illustrated in FIG. 6B, the cable-handling device 620 may dislodge from the cable-storage drum device 610 allowing the push-cable 630 stored in the cable-storage drum device 610 to be directed by the cable-handling device 620 and moved collaboratively by the cable-storage drum device 610 and the cable-handling device 620. In some such embodiments, a battery or other power source on the cable-handling device 620 may recharge while being stowed on the cable-storage drum device 610.

Some push-cable moving system embodiments of the present disclosure may allow a push-cable to freely move through the cable-handling device and movement of the push-cable is achieved via the drive element in the motorized cable-storage drum device. For instance, the input element may be on the cable-handling device for receiving input from the user in controlling the movement of the push-cable via a drive element in the motorized cable-storage drum device.

Turning to FIG. 7, a push-cable moving system 700 in keeping with the present disclosure is illustrated which may include a motorized cable-storage drum device 710 and a communicatively linked cable-handling device 720 configured for moving of a push-cable 730. Input control commands may be received at the cable-handling device 720 and be communicated to the motorized cable-storage drum device 710 via communication link 735. For instance, the user input may occur via a trigger, push buttons, voice control mechanisms, and/or other actuators for receiving commands from a user. Likewise, in some embodiments, such input control commands may be generated via a suite of sensors present at the distal end of a push-cable (e.g., accelerometer, gyroscopic sensors, compass sensors, other inertial sensors or arrays of sensors, image recognition of objects where a camera is present, and the like) to inform movements of the push-cable. Unlike other cable-handling devices of the present invention, the cable-handling device 720 lacking a drive element. For instance, the wheels 722 may be allowed to turn freely rather than be driven by a motor in moving the push-cable 730. In the push-cable moving system 700, movement of the push-cable 730 may instead be driven by the motorized cable-storage drum device 710 and controlled, fully or in part, from user input on the cable-handling device 720. In some such embodiments, input from a user 740 may additionally or instead be located in one or more wirelessly connected smartphones (e.g., a smartphone 745), tablets, laptops, or other computers or devices including other system devices (e.g., the motorized cable-storage drum device 710, a CCU 760, a utility locator device 770, a transmitter device 775, or the like).

The drive element of cable-handling devices and associated systems of the present invention may include a clutch mechanism to engage and disengage the drive element with a push-cable. In some such embodiments, the cable-handling device may engage a clutch mechanism with a push-cable at a first position, move the push-cable, disengage the clutch mechanism with the push-cable at a second position, and return a clutch mechanism to first position to re-engage with the push-cable in repeating the movement cycle of the push-cable.

Such a clutch mechanism (or other different mechanism in other embodiments not illustrated) may be configured to generate impulsive movement of a push-cable. For instance, the impulsive movements of the push-cable may be periodic push-cable movement with brief pauses between each instance of push-cable movement similar to the movements a user may be accustomed to when moving the push-cable by hand. Such impulsive push-cable movements may be useful in helping guide the push-cable through turns or through branches in the pipe or other void. In some such embodiments, such impulsive movement may be generated via a clutch mechanism engaging with the push-cable at a first position, move the push-cable, disengage the clutch mechanism with the push-cable at a second position, and return a clutch mechanism to first position to re-engage with the push-cable in repeating the cycle in moving the push-cable. For instance, one or more cams and/or gears, worm gear drives, or similar drive mechanisms may be configured in moving a clutch mechanism back and forth in generating such impulsive movements. It should be noted that though the subsequent embodiments may include a clutch mechanism to generate impulsive movements of a push-cable, other mechanisms may be included in embodiments in keeping with the present disclosure to generate impulsive push-cable movements, For instance, the wheeled drive element 550 of FIGS. 5B and 5C may be programmed to impart force in generating impulsive movements of the push-cable 530 (FIGS. 5A, 5B, and 5C). Likewise, it may be apparent to one knowledgeable in the art to utilize other drive mechanisms and configurations to generate impulsive movements.

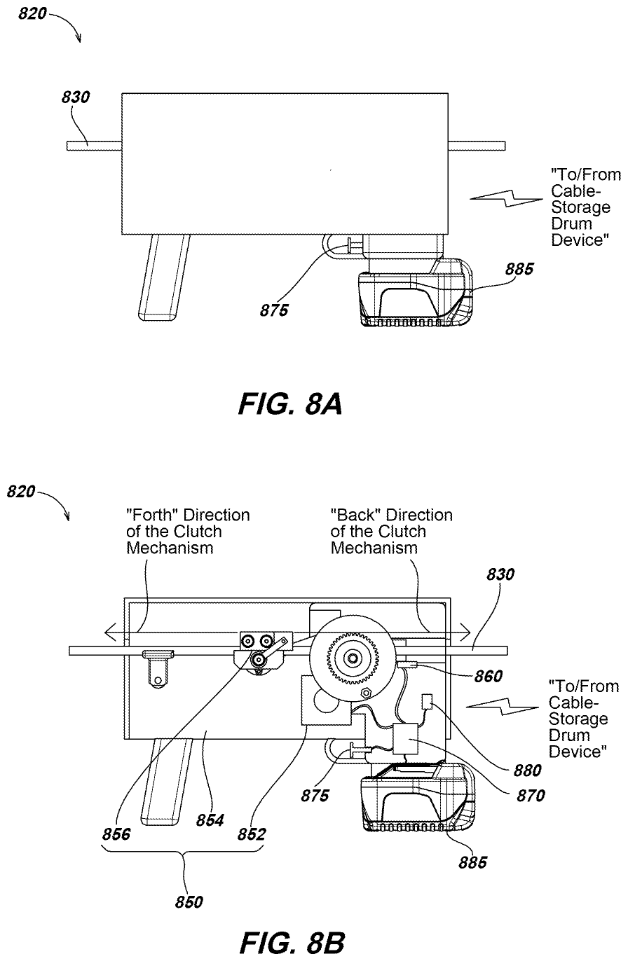

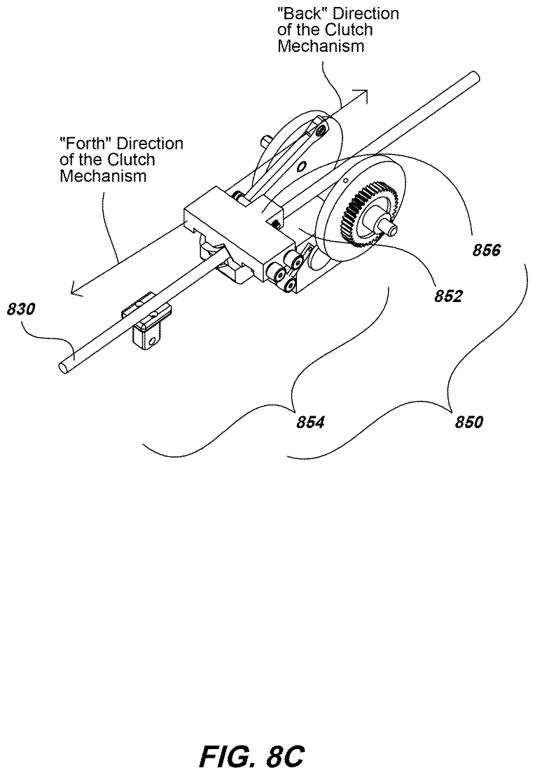

Turning to FIGS. 8A and 8B, a motorized cable-handling device 820 is illustrated which may be or share aspects with the cable-handling device 220 of FIG. 2, the cable-handling device 520 of FIGS. 5A-5D as well as other cable-handling devices disclosed herein. For instance, the cable-handling device 820 may be configured for the collaborative moving of a push-cable, such as the push-cable 830, with a motorized cable-storage drum device (e.g., the cable-storage drum device 210 of FIG. 2 or the cable-storage drum device 420 of FIGS. 4A-4C).

Illustrated in FIGS. 8B and 8C, the motorized cable-handling device 820 (FIG. 8B) may include a coupling element, such as a clutch mechanism 856, for coupling the cable-handling device 820 about the push-cable 830. The clutch mechanism 856 may be configured to engage and disengage with the push-cable 830 such that when the clutch mechanism 856 is engaged with the push-cable 830, the drive element 850 may impart force in generating dispensing and retracting movements of the push-cable 830. Other embodiments may include other coupling elements for securing a cable-handling device about a push-cable. A clutch mechanism, such as the clutch mechanism 856, may produce no relative motion between the drive element, such as the drive element 850, and the jacket of the push-cable, such as the push-cable 830, thus avoiding damage and prolonging the life of the push-cable. The drive element 850 may, in some embodiments, include one or more electric motors 852 for imparting force in turning a series of gears and cams 854 in moving the clutch mechanism 856 back and forth. For instance, the clutch mechanism 856 may engage with the push-cable 830 at a first position, move the push-cable 830, disengage the clutch mechanism 856 with the push-cable 830 at a second position, and return the clutch mechanism 856 to first position to re-engage with the push-cable 830 in repeating the movement cycle of the push-cable 830. In other words, the drive element 850 may be configured to generate impulsive movement of the push-cable 830 through the clutch mechanism 856 engaging with the push-cable 830 in one direction and disengaging on the return direction. Such impulsive movement of the push-cable 830 may be useful in helping guide the push-cable 830 through turns or through branches in a pipe or other void. It should be noted that in various different embodiments, such impulsive movements may occur in dispensing, retracting, or both dispensing and retracting movement of a push-cable.

Referring back to FIG. 8B, the cable-handling device 820 may include a measurement element 860 for generating measurement data relating to a measure of the amount of push-cable 830 dispensed. In some embodiments, such a measurement element may be or include optical sensors, mechanical sensors, or other sensors for measuring the amount of push-cable paid out. The measurement element 860 may be or include those as disclosed in U.S. Pat. No. 8,970,211, issued Mar. 3, 2015, entitled PIPE INSPECTION CABLE COUNTER AND OVERLAY MANAGEMENT SYSTEM; U.S. Pat. No. 10,527,402, issued Jan. 7, 2020, entitled PIPE INSPECTION CABLE COUNTER AND OVERLAY MANAGEMENT SYSTEM; and/or other devices and methods of the incorporated patents and applications for counting push-cable.

Still referring to FIG. 8B, the cable-handling device 820 may further include a control element 870 having one or more processors for generating control commands relating to the dispensing and retracting forces imparted by the drive element 850 in generating push-cable 830 movements that correspond with the dispensing/retracting movements imparted by a cable-storage drum device (e.g., the cable-storage drum device 210 of FIG. 2 or the cable-storage drum device 420 of FIGS. 4A-4C) and one or more non-transitory memories for storing instructions and data relating to push-cable 830 movements. In some embodiments, the control element 870 may fully or in part be located in one or more other wirelessly connected smartphones, tablets, laptops, or other computers or devices. An input element, such as the actuator 875, may directly or indirectly couple to the one or more processors of the control element 870 to generate control commands.

A communication element 880 may be included for communicating control commands relating to the dispensing/retracting movement control with a cable-storage drum device (e.g., the cable-storage drum device 210 of FIG. 2 or the cable-storage drum device 420 of FIGS. 4A-4C). For instance, the communication element 880 may include various wireless communication apparatus such as Bluetooth, Wi-Fi, ISM, or other radio or wireless technologies. In some embodiments the communication element 880 may instead or additionally include wires between the cable-handling device 820 and a cable-storage drum device (e.g., the cable-storage drum device 210 of FIG. 2 or the cable-storage drum device 420 of FIGS. 4A-4C). The cable-handling device 820 may further include a power element, such as a battery 885, for supplying of electrical power to powered elements of the cable-handling device 820. The battery 885 may be or with those disclosed in U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER and/or other batteries of the incorporated patents and applications. Optionally, the cable-handling device 820 may include a cleaning apparatus such as the cleaning element apparatus 590 of FIG. 5D.

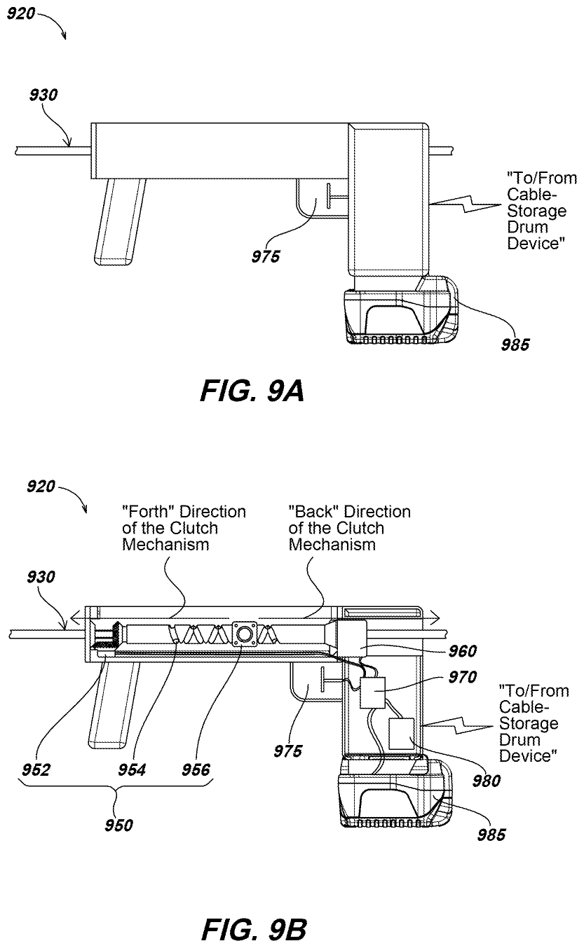

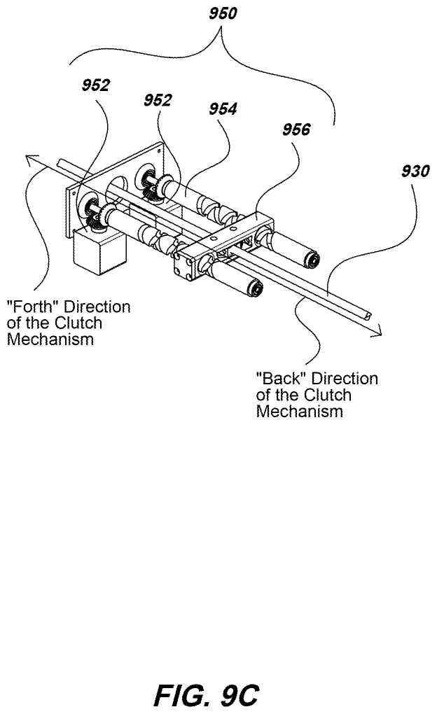

Turning to FIGS. 9A and 9B, another motorized cable-handling device 920 is illustrated which may be or share aspects with the cable-handling device 220 of FIG. 2, the cable-handling device 520 of FIGS. 5A-5D, the cable-handling device 820 of FIGS. 8A and 8B, as well as other cable-handling devices disclosed herein. For instance, the cable-handling device 920 may be configured for the collaborative moving of a push-cable, such as the push-cable 930, with a motorized cable-storage drum device (e.g., the cable-storage drum device 210 of FIG. 2 or the cable-storage drum device 420 of FIGS. 4A-4C).

Illustrated in FIGS. 9B and 9C, the motorized cable-handling device 920 (FIG. 9B) may include a coupling element, such as a clutch mechanism 956, for coupling the cable-handling device 920 about the push-cable 930. The clutch mechanism 956 may be configured to engage and disengage with the push-cable 930 such that when the clutch mechanism 956 is engaged with the push-cable 930, the drive element 950 may impart force in generating dispensing and retracting movements of the push-cable 930. Other embodiments may include other coupling elements for securing a cable-handling device about a push-cable. A clutch mechanism, such as the clutch mechanism 956, may produce no relative motion between the drive element, such as the drive element 950, and the jacket of the push-cable, such as the push-cable 930, thus avoiding damage to and prolonging the life of the push-cable. The drive element 950 may, in some embodiments, include one or more electric motors 952 for imparting force in turning a worm gear drive 954 in moving the clutch mechanism 956 back and forth. For instance, the clutch mechanism 956 may engage with the push-cable 930 at a first position, move the push-cable 930, disengage the clutch mechanism 956 with the push-cable 930 at a second position, and return the clutch mechanism 956 to first position to re-engage with the push-cable 930 in repeating the movement cycle of the push-cable 930. In other words, the drive element 950 may be configured to generate impulsive movement of the push-cable 930 through the clutch mechanism 956 engaging with the push-cable 930 in one direction and disengaging on the return direction. Such impulsive movement of the push-cable 930 may be useful in helping guide the push-cable 930 through turns or through branches in a pipe or other void. It should be noted that in various different embodiments, such impulsive movements may occur in dispensing, retracting, or both dispensing and retracting movement of a push-cable.

Referring back to FIG. 9B, the cable-handling device 920 may include a measurement element 960 for generating measurement data relating to a measure of the amount of push-cable 930 dispensed. In some embodiments, such a measurement element may be or include optical sensors, mechanical sensors, or other sensors for measuring the amount of push-cable paid out. The measurement element 960 may be or include those as disclosed in U.S. Pat. No. 8,970,211, issued Mar. 3, 2015, entitled PIPE INSPECTION CABLE COUNTER AND OVERLAY MANAGEMENT SYSTEM; U.S. Pat. No. 10,527,402, issued Jan. 7, 2020, entitled PIPE INSPECTION CABLE COUNTER AND OVERLAY MANAGEMENT SYSTEM; and/or other devices and methods of the incorporated patents and applications for counting push-cable.

Still referring to FIG. 9B, the cable-handling device 920 may further include a control element 970 having one or more processors for generating control commands relating to the dispensing and retracting forces imparted by the drive element 950 in generating push-cable 930 movements that correspond with the dispensing/retracting movements imparted by a cable-storage drum device (e.g., the cable-storage drum device 210 of FIG. 2 or the cable-storage drum device 420 of FIGS. 4A-4C) and one or more non-transitory memories for storing instructions and data relating to push-cable 930 movements. In some embodiments, the control element 970 may fully or in part be located in one or more other wirelessly connected smartphones, tablets, laptops, or other computers or devices. An input element, such as the actuator 975, may directly or indirectly couple to the one or more processors of the control element 970 to generate control commands based on input from a user. In some embodiments, the actuator 975 may instead be a trigger, one or more push buttons, voice control mechanisms, and/or other actuators for receiving commands from a user. Likewise, in some embodiments, such input control commands may be generated via a suite of sensors present at the distal end of a push-cable (e.g., accelerometer, gyroscopic sensors, compass sensors, other inertial sensors or arrays of sensors, image recognition of objects where a camera is present, and the like) to inform movements of the push-cable.

A communication element 980 may be included for communicating control commands relating to the dispensing/retracting movement control with a cable-storage drum device (e.g., the cable-storage drum device 210 of FIG. 2 or the cable-storage drum device 420 of FIGS. 4A-4C). For instance, the communication element 980 may include various wireless communication apparatus such as Bluetooth, Wi-Fi, ISM, or other radio or wireless technologies. In some embodiments the communication element 980 may instead or additionally include wires between the cable-handling device 920 and a cable-storage drum device (e.g., the cable-storage drum device 210 of FIG. 2 or the cable-storage drum device 420 of FIGS. 4A-4C). The cable-handling device 920 may further include a power element, such as a battery 985, for supplying of electrical power to powered elements of the cable-handling device 920. The battery 985 may be or with those disclosed in U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER and/or other batteries of the incorporated patents and applications. Optionally, the cable-handling device 920 may include a cleaning apparatus such as the cleaning element apparatus 590 of FIG. 5D.

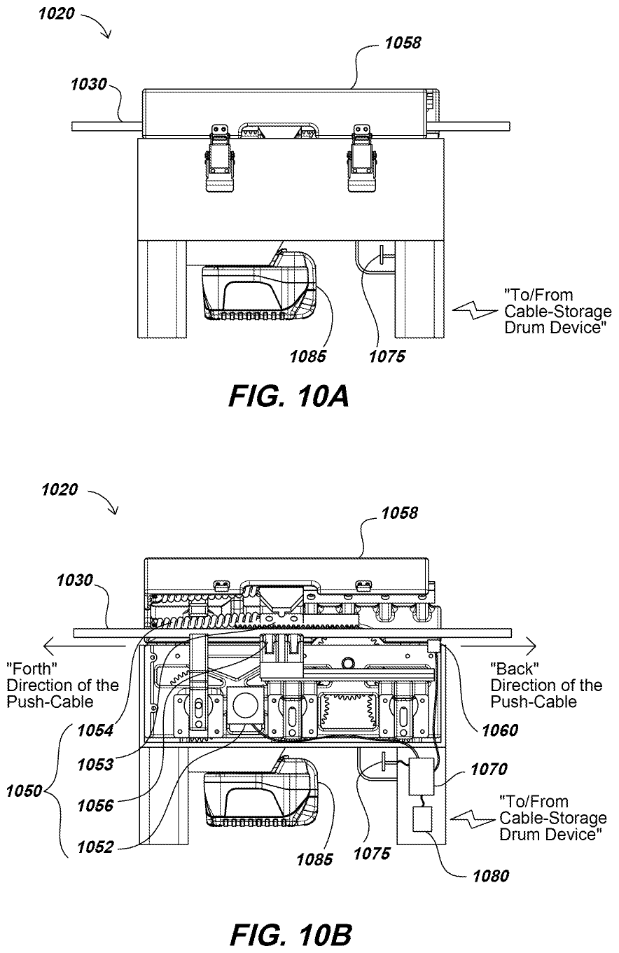

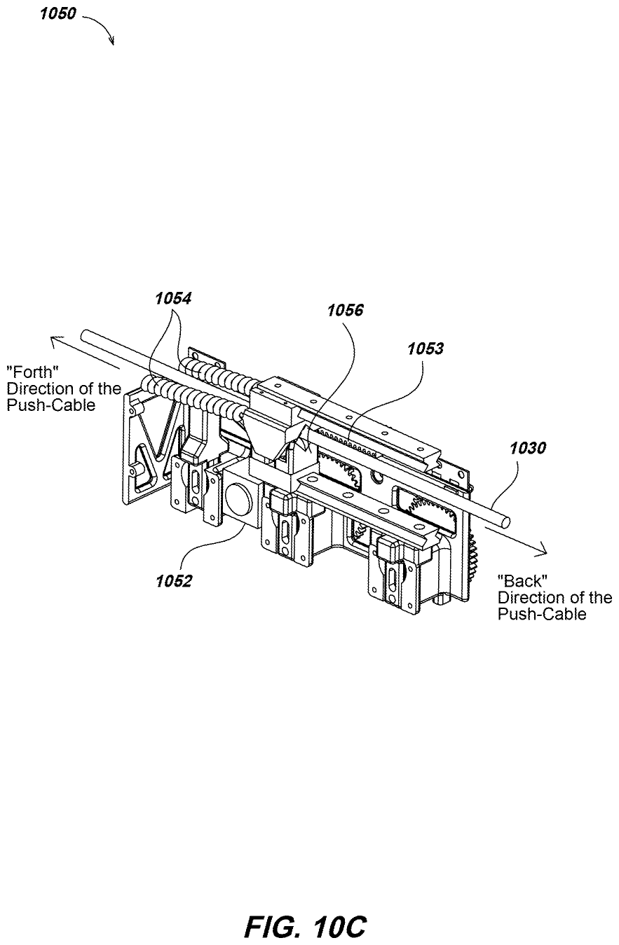

Turning to FIGS. 10A and 10B, another motorized cable-handling device 1020 is illustrated which may be or share aspects with the cable-handling device 220 of FIG. 2, the cable-handling device 520 of FIGS. 5A-5D, the cable-handling device 820 of FIGS. 8A and 8B, the cable-handling device 920 of FIGS. 9A and 9B, as well as other cable-handling devices disclosed herein. For instance, the cable-handling device 1020 may be configured for the collaborative moving of a push-cable, such as the push-cable 1030, with a motorized cable-storage drum device (e.g., the cable-storage drum device 210 of FIG. 2 or the cable-storage drum device 420 of FIGS. 4A-4C).

Illustrated in FIGS. 10B and 10C, the motorized cable-handling device 1020 (FIG. 10B) may include a coupling element, such as a clutch mechanism 1056, for coupling the cable-handling device 1020 (FIG. 10B) about the push-cable 1030. The clutch mechanism 1056 may be configured to engage and disengage with the push-cable 1030 such that when the clutch mechanism 1056 is engaged with the push-cable 1030, the drive element 1050 may impart force in generating dispensing and retracting movements of the push-cable 1030 (as indicated by “forth” and “back” movements of the clutch mechanism). A lid 1058 may be included allowing access in installing push-cable 1030 into the clutch mechanism 1056. Other embodiments may include other coupling elements for securing a cable-handling device about a push-cable. A clutch mechanism, such as the clutch mechanism 1056, may produce no relative motion between the drive element, such as the drive element 1050, and the jacket of the push-cable, such as the push-cable 1030, thus avoiding damage to and prolonging the life of the push-cable. The drive element 1050 may, in some embodiments, include one or more electric motors 1052 for imparting force in moving the clutch mechanism 1056 relative to a rack 1053 such that a set of springs 1054 may stretch storing energy therein until reaching the end of the rack 1053 where the clutch mechanism 1056 may become decoupled and return via the energy stored in the springs 1054 such that the clutch mechanism 1056 may move back and forth. The clutch mechanism 1056 may engage with the push-cable 1030 at a first position, move the push-cable 1030, disengage the clutch mechanism 1056 with the push-cable 1030 at a second position, and return the clutch mechanism 1056 to first position to re-engage with the push-cable 1030 in repeating the movement cycle of the push-cable 1030. In other words, the drive element 1050 may be configured to generate impulsive movement of the push-cable 1030 through the clutch mechanism 1056 engaging with the push-cable 1030 in one direction and disengaging on the return direction. Such impulsive movement of the push-cable 1030 may be useful in helping guide the push-cable 1030 through turns or through branches in a pipe or other void. It should be noted that in various different embodiments, such impulsive movements may occur in dispensing, retracting, or both dispensing and retracting movement of a push-cable.

Referring back to FIG. 10B, the cable-handling device 1020 may include a measurement element 1060 for generating measurement data relating to a measure of the amount of push-cable 1030 dispensed. In some embodiments, such a measurement element may be or include optical sensors, mechanical sensors, or other sensors for measuring the amount of push-cable paid out. The measurement element 1060 may be or include those as disclosed in U.S. Pat. No. 8,970,211, issued Mar. 3, 2015, entitled PIPE INSPECTION CABLE COUNTER AND OVERLAY MANAGEMENT SYSTEM; U.S. Pat. No. 10,527,402, issued Jan. 7, 2020, entitled PIPE INSPECTION CABLE COUNTER AND OVERLAY MANAGEMENT SYSTEM; and/or other devices and methods of the incorporated patents and applications for counting push-cable.

Still referring to FIG. 10B, the cable-handling device 1020 may further include a control element 1070 having one or more processors for generating control commands relating to the dispensing and retracting forces imparted by the drive element 1050 in generating push-cable 1030 movements that correspond with the dispensing/retracting movements imparted by a cable-storage drum device (e.g., the cable-storage drum device 210 of FIG. 2 or the cable-storage drum device 420 of FIGS. 4A-4C) and one or more non-transitory memories for storing instructions and data relating to push-cable 1030 movements. In some embodiments, the control element 1070 may fully or in part be located in one or more other wirelessly connected smartphones, tablets, laptops, or other computers or devices. An input element, such as the actuator 1075, may directly or indirectly couple to the one or more processors of the control element 1070 to generate control commands based on input from a user. In some embodiments, the actuator 1075 may instead be a trigger, one or more push buttons, voice control mechanisms, and/or other actuators for receiving commands from a user. Likewise, in some embodiments, such input control commands may be generated via a suite of sensors present at the distal end of a push-cable (e.g., accelerometer, gyroscopic sensors, compass sensors, other inertial sensors or arrays of sensors, image recognition of objects where a camera is present, and the like) to inform movements of the push-cable.

A communication element 1080 may be included for communicating control commands relating to the dispensing/retracting movement control with a cable-storage drum device (e.g., the cable-storage drum device 210 of FIG. 2 or the cable-storage drum device 420 of FIGS. 4A-4C). For instance, the communication element 1080 may include various wireless communication apparatus such as Bluetooth, Wi-Fi, ISM, or other radio or wireless technologies. In some embodiments the communication element 1080 may instead or additionally include wires between the cable-handling device 1020 and a cable-storage drum device (e.g., the cable-storage drum device 210 of FIG. 2 or the cable-storage drum device 420 of FIGS. 4A-4C). The cable-handling device 1020 may further include a power element, such as a battery 1085, for supplying of electrical power to powered elements of the cable-handling device 1020. The battery 1085 may be or with those disclosed in U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER and/or other batteries of the incorporated patents and applications. Optionally, the cable-handling device 1020 may include a cleaning apparatus such as the cleaning element apparatus 590 of FIG. 5D.

In some cable-handling devices and systems in keeping with the present disclosure, the drive element and associated optionally some associated element may be or include a power drill that may be removably coupled to the cable-handling device. The power drill may, when in use, provide the force to indirectly move a push-cable. For instance, a power drill may couple to a port on the cable-handling device and by actuating the power drill, force may be provided in turning gears or other mechanism in the cable-handling device that may further move the push-cable. In some embodiments, cable-handling devices in keeping with the present disclosure may, in some embodiments, utilize the actuator of the power drill fully such as the actuator 875 as the input element. In some embodiments, the addition input elements may also or instead be located on the cable-handling device.

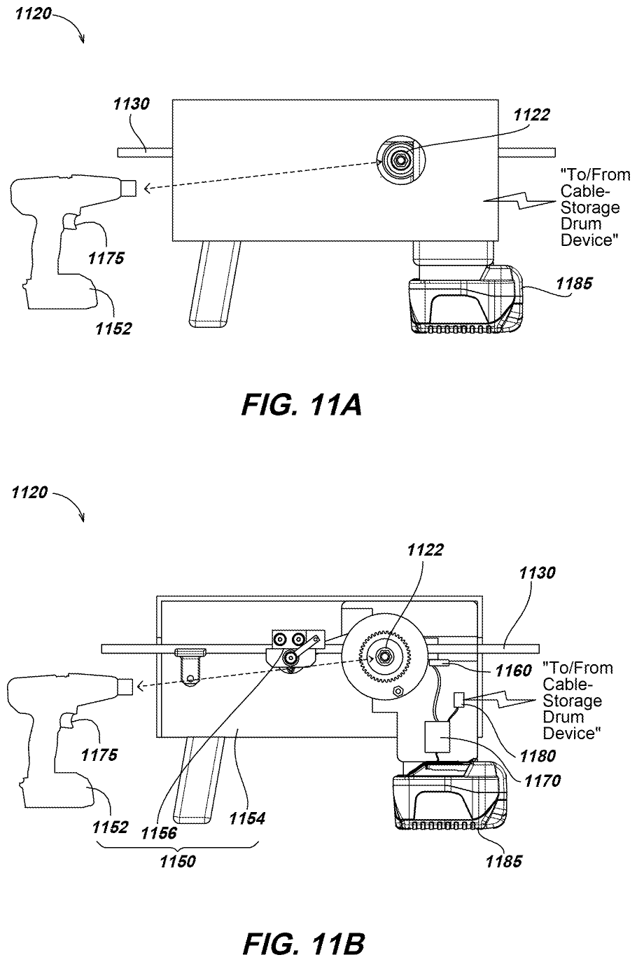

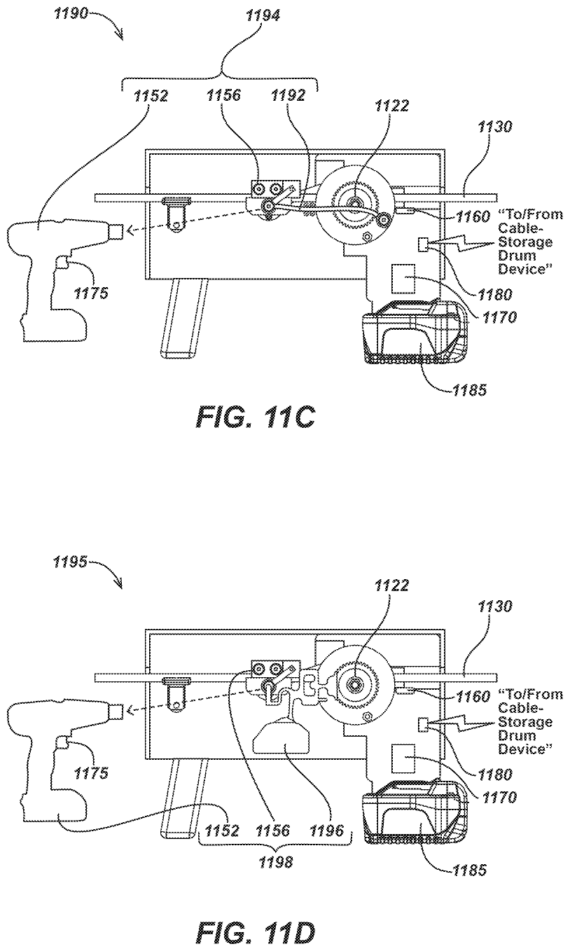

Turning to FIGS. 11A and 11B, a motorized cable-handling device 1120 is illustrated which may be or share aspects with the cable-handling device 820 of FIGS. 8A-8C wherein the mechanical force provided to a drive element 1150 (FIG. 11B) may be from a power drill 1152. The power drill 1152 may couple with the cable-handling device 1120 at a mounting port 1122. For instance, the mounting port 1122 may key into the jaws of the chuck on the power drill 1152 such that when the power drill 1152 is actuated via an input element 1175 (e.g., trigger or other actuator of the power drill 1152) the rotational force may be used to turn one or more gears and cams 1154 and/or other mechanism in moving a clutch mechanism 1156 or other coupling element and thereby move the push-cable 1130. The cable-handling device 1120 may be configured for the collaborative moving of the push-cable 1130 with a motorized cable-storage drum device (e.g., the cable-storage drum device 210 of FIG. 2 or the cable-storage drum device 420 of FIGS. 4A-4C).

Illustrated in FIG. 11B, the clutch mechanism 1156 may be configured to engage and disengage with the push-cable 1130 such that when the clutch mechanism 1156 is engaged with the push-cable 1130, the drive element 1150 may impart force in generating dispensing and retracting movements of the push-cable 1130. The drive element 1150 may, in some embodiments, include one or more electric motors 1152 for imparting force in turning gears and cams 1154 and moving the clutch mechanism 1156 and thereby move the push-cable 1130. For instance, the clutch mechanism 1156 may engage with the push-cable 1130 at a first position, move the push-cable 1130, disengage the clutch mechanism 1156 with the push-cable 1130 at a second position, and return the clutch mechanism 1156 to first position to re-engage with the push-cable 1130 in repeating the movement cycle of the push-cable 1130. In other words, the drive element 1150 may be configured to generate impulsive movement of the push-cable 1130 through the clutch mechanism 1156 engaging with the push-cable 1130 in one direction and disengaging on the return direction. It should be noted that in various different embodiments, such impulsive movements may occur in dispensing, retracting, or both dispensing and retracting movement of a push-cable.

Still referring to FIG. 11B, the cable-handling device 1120 may include a measurement element 1160 for generating measurement data relating to a measure of the amount of push-cable 1130 dispensed. In some embodiments, such a measurement element may be or include optical sensors, mechanical sensors, or other sensors for measuring the amount of push-cable paid out. The measurement element 1160 may be or include those as disclosed in U.S. Pat. No. 8,970,211, issued Mar. 3, 2015, entitled PIPE INSPECTION CABLE COUNTER AND OVERLAY MANAGEMENT SYSTEM; U.S. Pat. No. 10,527,402, issued Jan. 7, 2020, entitled PIPE INSPECTION CABLE COUNTER AND OVERLAY MANAGEMENT SYSTEM; and/or other devices and methods of the incorporated patents and applications for counting push-cable.

Still referring to FIG. 11B, the cable-handling device 1120 may further include a control element 1170 having one or more processors for generating control commands relating to the dispensing and retracting forces imparted by the drive element 1150 in generating push-cable 1130 movements that correspond with the dispensing/retracting movements imparted by a cable-storage drum device (e.g., the cable-storage drum device 210 of FIG. 2 or the cable-storage drum device 420 of FIGS. 4A-4C) and one or more non-transitory memories for storing instructions and data relating to push-cable 1130 movements. For instance, the push-cable 1130 movements may be measured by the measurement element 1160 and commands may be generated by the control element 1170 relating to the rate and direction of the push-cable 1130 further communicated with movement with a cable-storage drum device (e.g., the cable-storage drum device 210 of FIG. 2 or the cable-storage drum device 420 of FIGS. 4A-4C) via a communication element 1180. For instance, the communication element 1180 may include various wireless communication apparatus such as Bluetooth, Wi-Fi, ISM, or other radio or wireless technologies. In some embodiments the communication element 1180 may instead or additionally include wires between the cable-handling device 1120 and a cable-storage drum device (e.g., the cable-storage drum device 210 of FIG. 2 or the cable-storage drum device 420 of FIGS. 4A-4C). The cable-handling device 1120 may further include a power element, such as a battery 1185, for supplying of electrical power to powered elements of the cable-handling device 1120. The battery 1185 may be or with those disclosed in U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER and/or other batteries of the incorporated patents and applications. Optionally, the cable-handling device 1-20 may include a cleaning apparatus such as the cleaning element apparatus 590 of FIG. 5D.

The various embodiments disclosed in the present application may include or utilize a flexure or compliant mechanism drive for moving a push-cable. As used herein, the terms “compliant mechanism” or “flexure mechanism” is one that achieves force and motion transmission through elastic body transformation. Specifically, such a compliant mechanism may be used to move, grasp, or both grasp and move the push-cable through elastic body transformations.

As illustrated in FIG. 11C, a cable-handling device 1190 is illustrated which may be the same or share aspects with the cable-handling device 1120 of FIG. 11B having a compliant mechanism 1192 instead of various gears, cams, cranks, and like mechanisms in moving the push-cable 1130 which may be coordinated with a cable-storage drum device. As illustrated, the compliant mechanism 1192 may be adapted to produce the same output for a given input as the gears, cams, cranks, and so from FIG. 11B. The compliant mechanism 1192 may be a part of a drive element 1194 (which may include the power drill 1152, the clutch mechanism 1156, and the compliant mechanism 1192) connecting the compliant mechanism 1192 with the clutch mechanism 1156 further driven by the power drill 1152 via the mounting port 1122. As the power drill 1152 is actuated, the mounting port 1122 may turn causing the elastic/flexible compliant mechanism 1192 to deform as it moves back and forth and, in turn, move the clutch mechanism 1156. The clutch mechanism 1156 may grasp the push-cable 1130 in moving the push-cable 1130 in the desired direction but not the other.

As illustrated in FIG. 11C, a cable-handling device 1195 is illustrated which may be the same or share aspects with the cable-handling device 1120 of FIG. 11B having a different compliant mechanism 1196 instead of various gears, cams, cranks, and like mechanisms in moving the push-cable 1130 which may be coordinated with a cable-storage drum device. As illustrated, the compliant mechanism 1196 may be adapted to produce the same output for a given input as the gears, cams, cranks, and so from FIG. 11B. The compliant mechanism 1196 may be a part of a drive element 1198 (which may include the power drill 1152, the clutch mechanism 1156, and the compliant mechanism 1196) connecting the compliant mechanism 1196 with the clutch mechanism 1156 further driven by the power drill 1152 via the mounting port 1122. As the power drill 1152 is actuated, the mounting port 1122 may turn causing the elastic/flexible compliant mechanism 1196 to deform as it moves back and forth and, in turn, move the clutch mechanism 1156. The clutch mechanism 1156 may grasp the push-cable 1130 in moving the push-cable 1130 in the desired direction but not the other.

In other embodiments, a flexure/compliant mechanism may likewise be used for the clutch mechanism (e.g., the clutch mechanism 1156 of FIGS. 11A, 11B, 11C, and 11D) or a flexure/compliant mechanism may both be the clutch mechanism (e.g., the clutch mechanism 1156 of FIGS. 11A, 11B, 11C, and 11D) as well as be the mechanism in moving the clutch mechanism in a singular component. For instance, in such embodiments having a singular compliant mechanism that includes a clutch to grip a push-cable, an integrated motive source may actuate a compliant mechanism drive following the same general principle of timed clamping force on the cable, followed by to/from motion of the cable, followed by releasing the cable, followed by repositioning of the clamping element, and re-starting the cycle.

In some configurations, the apparatus or systems described herein may include means for implementing features or providing functions described herein. In one aspect, the aforementioned means may be a module including a processor or processors, associated memory and/or other electronics in which embodiments of the invention reside, such as to implement image and/or video signal processing, switching, transmission, or other functions to process and/or condition camera outputs, control lighting elements, control camera selection, or provide other electronic or optical functions described herein. These may be, for example, modules or apparatus residing in camera assemblies, camera and lighting assemblies, or other assemblies disposed on or within a push-cable or similar apparatus.

Those of skill in the art would understand that information and signals, such as video and/or audio signals or data, control signals, or other signals or data may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, electro-mechanical components, or combinations thereof. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative functions and circuits described in connection with the embodiments disclosed herein with respect to tools, instruments, and other described devices may be implemented or performed in one or more processing elements using elements such as a general or special purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Processing elements may include hardware and/or software/firmware to implement the functions described herein in various combinations.

The previous description of the disclosed embodiments is provided to enable any person skilled in the art to make or use various embodiments. Various modifications to these embodiments will be readily apparent to those skilled in the art, and the generic principles defined herein may be applied to other embodiments without departing from the spirit or scope of the disclosure.

Accordingly, the presently claimed invention is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the scope of the present disclosure is not intended to be limited to the aspects shown herein but is to be accorded the widest scope consistent with the appended claims and their equivalents.

1. A motorized cable-handling device, comprising;
a coupling element for coupling the cable-handling device about a push-cable;
a drive element for imparting force in generating dispensing and retracting movements of the push-cable;
a measurement element for generating measurement data relating to a measure of the amount of push-cable dispensed;
an input element for receiving input relating to the dispensing and retracting movements of the push-cable;
a control element having one or more processors for generating control commands relating to the dispensing and retracting forces imparted by the drive element in generating push-cable movements that correspond with the dispensing/retracting movements imparted by a cable-storage drum device and one or more non-transitory memories for storing instructions and data relating to push-cable movements;
a communication element for communicating control commands relating to the dispensing/retracting movement control with a cable-storage drum device; and
a power element for supplying of electrical power to powered elements of the cable-handling device.

2. The devices of claim 1, configured for use in a pipe inspection system.

3. The device of claim 1, configured for use in a utility locating system.

4. The device of claim 1, wherein the drive element includes one or more electric motors for moving a push-cable.

5. The device of claim 1, wherein the communication element includes Bluetooth, Wi-Fi, or other wireless communication apparatus.

6. The device of claim 1, wherein the power element includes one or more batteries.

7. The device of claim 1, wherein the control element is governed by measurement data of the amount of push-cable dispensed produced by a cable-storage drum device to ensure synchronous movement of the push-cable from the cable-handling device and the cable-storage drum device.

8. The device of claim 1, wherein the control element is governed by the measurement data produced by the measurement element of the cable-handling device that is further shared with a cable-storage-drum device to ensure synchronous movement of the push-cable from the cable-handling device and the cable-storage drum device.

9. The device of claim 1, further including a cleaning element to wipe or clean the push-cable during dispensing or retracting movements.

10. The device of claim 1, wherein the control element is fully or in part in one or more other wirelessly connected smartphones, tablets, laptops, or other computers or devices.

11. The device of claim 1, wherein the input element is fully or in part in one or more other wirelessly connected smartphones, tablets, laptops, or other computers or devices.

12. The device of claim 1, wherein the input element is fully or in part located in one or more other wirelessly connected smartphones, tablets, laptops, or other computers or devices.

13. The device of claim 1, wherein the input element includes a trigger, buttons, or mechanism by which a user can input commands.

14. The device of claim 1, wherein the input element includes mechanisms for voice command.

15. The device of claim 1, wherein the drive element includes a clutch element to engage and disengage with the push-cable.

16. The device of claim 1, wherein the drive element is provided by a power drill removably coupled to the cable-handling device.

17. The device of claim 1, wherein the drive element imparts forces to cause impulsive movements of the push-cable.

18. The device of claim 1, including a flexure or compliant mechanism in moving a push-cable.

19-51. (canceled)
